(19) United States
(12) Patent Application Publication
(10) Pub. No.: US 2007/0195229 A1
(43) Pub. Date: Aug. 23, 2007

(54) LIQUID CRYSTAL DEVICE AND ELECTRONIC DEVICE

(75) Inventors: Mitsuru KURIBAYASHI, Chino (JP); Kazumi ARUGA, Fujimi (JP); Akira INAGAKI, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/619,840

(22) Filed: Jan. 4, 2007

(30) Foreign Application Priority Data
Feb. 20, 2006 (JP) 2006-042008

(51) Int. Cl. G02F 1/1335

(52) U.S. Cl. 349/106

(57) ABSTRACT

A liquid crystal device includes: an electrode substrate having a plurality of pixel electrodes; an opposing substrate facing the electrode substrate; a color filter having a color element each facing each of the plurality of pixel electrodes; a liquid crystal sandwiched between the electrode substrate and the opposing substrate; and an alignment-control unit extending on a surface having contact with the liquid crystal in at least one of the electrode substrate and the opposing substrate. Colors for the color element include four or more colors and the alignment-control unit extends along a same direction in each position corresponding to the color element for at least any of predetermined three of the four or more colors.

### BACKGROUND

1. Technical Field

The present invention relates to a liquid crystal device and an electronic device having the liquid crystal device.

2. Related Art

A liquid crystal device such as a liquid crystal display (LCD), etc. has been conventionally known. In LCD, there is a pixel including a pixel electrode and a liquid crystal inside and a unit configuring an image. An image is formed by controlling the alignment direction of the liquid crystal with applying a voltage to the pixel electrode. A liquid crystal display is equivalent to a cathode ray tube (CRT) in terms of image qualities such as contrast and color reproduction when viewed straight. However, a liquid crystal display has a disadvantage of a narrower viewing angle compared to a CRT because of viewing-angle dependency in image quality. In a first example of related art, a liquid crystal display in which the viewing angle can be widened by providing an alignment-control unit (domain-controlling element) to control the alignment direction of liquid crystal has been disclosed.

Further, to display a color image, each of filters of, for example, the three primary colors of light including red, green, and blue are formed one each for each pixel. Pixels having red, green, and blue filters are regarded as pixels having the respective colors. By individually changing the intensities of red, green, and blue included in a unit (hereinafter referred to as “picture element”) having one or more pixels for each of the red, green, and blue pixels to configure a color image, the color of the picture element is reproduced. To widen the reproducible color gamut, multi-color filters having a filter of another color in addition to red, green, and blue is used. Multi-color filters include the following: six-color filters having filters of not only red, green, and blue but also cyan (blue-green), magenta (purple-red), and yellow, which are the complementary colors of red, green, and blue; four-complementary-color filters having filters of not only cyan, magenta, and yellow but also green; etc. In a second example of related art, various multi-color filters and an electrooptical panel including multi-color filters have been disclosed.

Japanese Patent No. 2,947,350 is the first example of related art.

JP-A-2002-286927 is the second example of related art.

Regarding the alignment-control unit (domain-controlling element) disclosed in the first example of related art, however, no considerations on a liquid crystal display having multi-color filters as disclosed in the second example of related art have been taken. In other words, there has been a problem in multi-color filters that when the viewing angle is widened for each color by using an alignment-control unit, the balance of colors is not always maintained in the widened viewing angle.

### SUMMARY

An advantage of the invention is to provide a liquid crystal device having multi-color filters and an electronic device including the liquid crystal device, in which the viewing angle can be widened while the color balance is maintained.

According to a first aspect of the invention, a liquid crystal device includes four or more colors for color elements. In the liquid crystal device, an electrode substrate having a plurality of pixel electrodes, an opposing substrate facing the electrode substrate, a color filter having the color elements each facing each of the plurality of pixel electrodes, liquid crystal sandwiched between the electrode substrate and the opposing substrate, and an alignment-control unit extending on at least either of the electrode substrate and the opposing substrate on a surface having contact with the liquid crystal are provided; and the alignment-control unit extends along the same direction in each position corresponding to the color element for at least any of predetermined three of the four or more colors.

A liquid crystal device having multi-color filters creates the colors of a color image by changing the individual intensities of the colors in a unit (hereinafter referred to as “picture element”) including pixels having color elements of given colors one or more for each of the colors to configure a color image. The color within a polygon formed on a gamut by connecting the points of the respective colors included in the multi-color filter can be reproduced. With at least the pixels of three colors, the color within a triangle formed on a gamut by connecting the points of the three colors can be reproduced. In the liquid crystal device according to the first aspect of the invention, the alignment-control unit extends along the same direction in each position corresponding to the color elements for at least three colors configuring a picture element. Hence, the alignment direction of liquid crystal is the same at each of the pixels for at least the three colors configuring a picture element. Therefore, the alignment direction of liquid crystal is the same at each of the color elements for at least the three colors configuring a picture element. Consequently, the viewing angle can be widened while the color balance of the picture element is maintained regarding at least the color within a triangle formed on a gamut by the three colors.

In the above liquid crystal device, it is preferable that the alignment-control unit formed in each position corresponding to the color element for a color other than the predetermined colors extend along the same direction as that for the alignment-control unit formed in each position corresponding to the color element for any of the predetermined colors.

In the configuration of such a liquid crystal device, the alignment-control unit extends along the same direction in each position corresponding to the color elements for the colors configuring a picture element. Hence, the alignment direction of liquid crystal is the same at each of the pixels for the colors configuring a picture element. Therefore, the alignment direction of liquid crystal is the same at each of the pixels, i.e., each of the color elements, configuring a picture element. Consequently, the viewing angle can be widened while the color balance of the picture element is maintained.

In the above liquid crystal device, it is preferable that the predetermined colors be three primary colors including red, green, and blue.

Many liquid crystal devices having multi-color filters include pixels having color elements for the respective colors of the three primary colors of light because of the capability of achieving a large color reproduction region with few colors. In such a configuration, the alignment-control unit extends along the same direction in each position corresponding to the color elements for the three primary colors of light configuring a picture element. Hence, the alignment direction of liquid crystal is the same at each of the pixels for the three primary colors of light configuring a picture element. Therefore, the alignment direction of liquid crystal is the same at each of the color elements for the three primary colors of light configuring a picture element. Consequently, the viewing angle can be widened while the color balance of the picture element is maintained regarding the color within a triangle formed on a gamut by the three primary colors of light.

In the above liquid crystal device, it is preferable that the alignment-control unit extend along the same direction in each position corresponding to the color element for a color other than the three primary colors.

In such a configuration, the alignment-control unit extends along the same direction in each position corresponding to the color element for a color other than the three primary colors of light configuring a picture element. Hence, the alignment direction of liquid crystal is the same at each of the pixels for the color other than the three primary colors of light configuring a picture element. Consequently, the viewing angle can be widened while maintaining the color balance of the picture element regarding not only the color within a triangle formed on a gamut by the three primary colors of light but also the color other than the three primary colors of light.

In the above liquid crystal device, it is preferable that the predetermined colors be any of cyan, magenta, and yellow, which are the complementary colors of the three respective primary colors including red, green, and blue.

To achieve a liquid crystal device with higher brightness, there is a known liquid crystal device including a complementary-color filter having color elements for the complementary colors of the three primary colors of light where a wide color reproduction region equivalent to that for the three primary colors of light can be obtained, as well as a brighter image with the colors lighter than the three primary colors of light. In such a configuration, the alignment-control unit extends along the same direction in each position corresponding to the color elements for the complementary colors of the three primary colors of light configuring a picture element. Hence, the alignment direction of liquid crystal is the same at each of the pixels for the complementary colors of the three primary colors of light configuring a picture element. Therefore, the alignment direction of liquid crystal is the same at each of the color elements for the complementary colors of the three primary colors of light configuring a picture element. Consequently, the viewing angle can be widened while the color balance of the picture element is maintained regarding the color within a triangle formed on a gamut by the complementary colors of the three primary colors of light.

In the above liquid crystal device, it is preferable that the alignment-control unit extend along the same direction in each position corresponding to the color element for a color other than the complementary colors of the three primary colors.

In such a configuration, the alignment-control unit extends along the same direction in each position corresponding to the color element for a color other than the complementary colors of the three primary colors of light configuring a picture element. Hence, the alignment direction of liquid crystal is the same at each of the pixels for the color other than the complementary colors of the three primary colors of light configuring a picture element. Consequently, the viewing angle can be widened while maintaining the color balance of the picture element regarding not only the color within a triangle formed on a gamut by the complementary colors of the three primary colors of light but also the color other than the complementary colors of the three primary colors of light.

According to a second aspect of the invention, a liquid crystal device includes three primary colors including red, green, and blue and complementary colors of the three primary colors including cyan, magenta, and yellow for color elements. In the liquid crystal device, an electrode substrate having a plurality of pixel electrodes, an opposing substrate facing the electrode substrate, a color filter having the color elements each facing each of the plurality of pixel electrodes, liquid crystal sandwiched between the electrode substrate and the opposing substrate, and an alignment-control unit extending on dat least either of the electrode substrate and the opposing substrate on a surface having contact with the liquid crystal are provided; the alignment-control unit extends along the same direction in each position corresponding to the color element for any of the three primary colors; and the alignment-control unit extends along the same direction in each position corresponding to the color element for any of the complementary colors of the three primary colors.

In the liquid crystal device according to the second aspect of the invention, the alignment-control unit extends along the same direction in each position corresponding to the color elements for the three primary colors of light configuring a picture element. Hence, the alignment direction of liquid crystal is the same at each of the pixels for the three primary colors of light configuring a picture element. Therefore, the alignment direction of liquid crystal is the same at each of the color elements for the three primary colors of light configuring a picture element. Consequently, the viewing angle can be widened while the color balance of the picture element is maintained regarding the color within a triangle formed on a gamut by the three primary colors of light. Likewise, regarding the color within a triangle formed on a gamut by the complementary colors of the three primary colors of light, the viewing angle can be widened while the color balance of the picture element is maintained.

According to a third aspect of the invention, a liquid crystal device includes three primary colors including red, green, and blue and complementary colors of the three primary colors including cyan, magenta, and yellow for color elements. In the liquid crystal device, an electrode substrate having a plurality of pixel electrodes, an opposing substrate facing the electrode substrate, a color filter having the color elements each facing each of the plurality of pixel electrodes, liquid crystal sandwiched between the electrode substrate and the opposing substrate, and an alignment-control unit extending on at least either of the electrode substrate and the opposing substrate on a surface having contact with the liquid crystal are provided; and the alignment-control unit extends along the same direction in each position corresponding to the color elements for each complementary pair of colors.

In the liquid crystal device according to the third aspect of the invention, the alignment-control unit extends along the same direction in each position corresponding to the color elements for each complementary pair of colors. Hence, the alignment direction of liquid crystal is the same at each of the pixels for each complementary pair of colors configuring a picture element. Therefore, the alignment direction of liquid crystal is the same at each of the color elements for each complementary pair of colors configuring a picture element. Consequently, the viewing angle can be widened while the color balance of the picture element is maintained regarding each complementary pair of colors.

According to a fourth aspect of the invention, a liquid crystal device includes first color elements having a first area as an effective area for light transmission; and second color elements having a second area as the effective area. In the liquid crystal device, an electrode substrate having a plurality of pixel electrodes, an opposing substrate facing the electrode substrate, a color filter having the color elements each facing each of the plurality of pixel electrodes, liquid crystal sandwiched between the electrode substrate and the opposing substrate, and an alignment-control unit extending on at least either of the electrode substrate and the opposing substrate on a surface having contact with the liquid crystal are provided; and the alignment-control unit extends along the same direction in each position corresponding to at least either of the first color elements and the second color elements between the colors of the first color elements or between the colors of the second color elements.

In the liquid crystal device according to the fourth aspect of the invention, the alignment-control unit formed in each position corresponding to the color elements having the same effective area extends along the same direction between the colors of those color elements. Hence, the alignment directions of liquid crystal is the same at each of the pixels having the same effective area. Therefore, the alignment direction of liquid crystal is the same between the colors of the color elements having the same effective area and configuring a picture element. Consequently, the viewing angle can be widened while the color balance of the picture element is maintained regarding the color within a polygon formed on a gamut by the colors of the color elements having the same effective area.

According to a fifth aspect of the invention, a liquid crystal device includes first color elements having a first area as an effective area for light transmission; and second color elements having a second area as the effective area. In the liquid crystal device, an electrode substrate having a plurality of pixel electrodes, an opposing substrate facing the electrode substrate, a color filter having the color elements each facing each of the plurality of pixel electrodes, liquid crystal sandwiched between the electrode substrate and the opposing substrate, and an alignment-control unit extending on at least either of the electrode substrate and the opposing substrate on a surface having contact with the liquid crystal are provided; the direction along which the alignment-control unit extend is determined for each color; and the alignment-control unit formed in each position corresponding to the first color elements having a first color extends along the same direction as that for the alignment-control unit formed in each position corresponding to the second color elements having a second color complementary to the first color.

In multi-color filters, the effective area is varied depending on the colors of the color elements so as to maintain an appropriate color balance. In the liquid crystal device according to the fifth aspect of the invention, the alignment-control unit extends along the same direction in each position corresponding to the color elements for a complementary pair of colors having different effective areas. Hence, the alignment directios of liquid crystal is the same at each of the pixels for the complementary pair of colors configuring a picture element. Therefore, the alignment direction of liquid crystal is the same at each of the color elements for the complementary pair of colors configuring a picture element. Consequently, the viewing angle can be widened while the color balance of the picture element is maintained regarding the complementary pair of colors.

In the above liquid crystal device, it is preferable that the alignment-control unit extend along the same direction in each position corresponding to each of the color elements.

In such a configuration, the alignment-control unit extends along the same direction in each position corresponding to the color elements for the respective colors configuring a picture element. Hence, the alignment direction of liquid crystal is the same at each of the pixels for the respective colors configuring a picture element. Therefore, the alignment direction of liquid crystal is the same at each of the pixels, i.e., each of the color elements, configuring a picture element. Consequently, the viewing angle can be widened while the color balance of the picture element is maintained.

In the above liquid crystal device, it is preferable that the direction along which the alignment-control unit extend include a first extending direction and a second extending direction and that the alignment-control unit corresponding to one color element include both the alignment-control unit provided along the first extending direction and the alignment-control unit provided along the second extending direction.

By providing an alignment-control unit extending along one direction, the viewing angle along the one direction can be widened. The viewing angle along one direction is a viewing angle along, for example, the horizontal, vertical, or diagonal direction of a liquid crystal device. In such a configuration, the viewing angle can be widened along two directions by the alignment-control units extending along two directions.

In the above liquid crystal device, it is preferable that the alignment-control unit be a protrusion formed on the surface having contact with the liquid crystal or a recess formed in the surface having contact with the liquid crystal.

In such a configuration, the protrusion or recess functions as the alignment-control unit for controlling the direction to which the liquid crystal is slanted. In a liquid crystal device where no drive voltage is applied to pixel electrodes provided for aligning liquid crystal, the liquid crystal molecules of the liquid crystal are aligned vertically to an alignment layer. When a protrusion or a recess is formed on or in a flat surface having contact with the liquid crystal layer, the liquid crystal molecules on the sidewalls of the protrusion or recess are aligned almost vertically to the sidewalls of the protrusion or recess, that is, slanted with respect to the flat surface. When a predetermined drive voltage is applied to the pixel electrodes, the liquid crystal molecules turn to a direction vertical to the magnetic field. Under such circumstances, the liquid crystal molecules which are slanted to one direction with no drive voltage applied are further slanted to that direction to change their alignment direction, and other liquid crystal molecules around the former ones are also slanted to the same direction to change their alignment direction under the influence of the former ones. Thus, the liquid crystal molecules are slanted to a uniform direction.

In the above liquid crystal device, either or both of the protrusion and the recess may be formed for each of the color elements.

In the above liquid crystal device, it is preferable that the recess be formed by providing a slit in the pixel electrode.

In such a configuration, the recess can be formed only by forming a slit in the pixel electrode without the need of providing other members for forming the recess.

In the above liquid crystal device, it is preferable that the alignment-control unit be a space between adjacent pixel electrodes.

In a liquid crystal device of an in-plane switching (IPS) method, pixel electrodes are formed on one of the surfaces sandwiching and having contact with a liquid crystal layer, with at least two or more independent pixel electrodes in one pixel. When a drive voltage is applied between the pixel electrodes in a pixel, liquid crystal molecules aligned almost vertically to the pixel electrode surfaces with no drive voltage applied turn to a direction almost parallel to the pixel electrode surfaces. Under such circumstances, the liquid crystal molecules aligned almost vertically to the pixel electrode surfaces change their alignment direction to be slanted toward the space between the two pixel electrodes to which the drive voltage is applied. Therefore, the space between the pixel electrodes functions as an alignment-control unit.

According to a sixth aspect of the invention, an electronic device includes the liquid crystal device according to any of the first to fifth aspects of the invention.

In the electronic device according to the sixth aspect of the invention, a preferable electronic device having a wide viewing angle and well-balanced colors can be achieved by including a liquid crystal device in which the viewing angle can be widened while the color balance of the picture element is maintained.

### BRIEF DESCRIPTION OF THE DRAWINGS

The invention will be described with reference to the accompanying drawings, wherein like numbers reference like elements.

FIG. 1 is an exploded perspective view of a liquid crystal display according to the invention.

FIG. 2 is a cross-sectional view of the liquid crystal display taken along the line A-A in FIG. 1.

FIG. 3A is a schematic plan view showing the configuration of a color filter.

FIG. 3B is a schematic plan view showing the configuration of a mother substrate on which a plurality of second substrates are formed.

FIG. 4A is a plan view showing an example of color element arrangement in a four-color filter.

FIGS. 4B and 4C are plan views showing examples of color element arrangement in a six-color filter.

FIGS. 5A and 5B are schematic perspective views showing external appearances of a droplet ejection head.

FIG. 6A is a perspective view showing the configuration of a droplet ejection head.

FIG. 6B is a cross-sectional view showing the detailed configuration of an ejection nozzle of the droplet ejection head.

FIG. 7 is a flow chart showing the steps of manufacturing a color filter substrate.

FIGS. 8A to 8G are schematic cross-sectional views showing the steps of manufacturing a color filter substrate.

FIG. 9 is a flow chart showing the steps of manufacturing a liquid crystal display.

FIGS. 10A to 10C are schematic cross-sectional views showing the steps of forming a second substrate.

FIG. 11 is a cross-sectional view of a liquid crystal panel showing the liquid crystal alignment direction when no drive voltage is applied in a liquid crystal panel including protrusions formed on the surfaces having contact with a liquid crystal layer.

FIG. 12 is a plan view showing how protrusions extend in one picture element of a four-color filter.

FIG. 13 is a plan view showing how protrusions extend in one picture element of a six-color filter.

FIG. 14 is another plan view showing how protrusions extend in one picture element of a six-color filter.

FIG. 15A is a cross-sectional view of a liquid crystal panel showing the liquid crystal alignment direction when no drive voltage is applied in the liquid crystal panel including recesses formed in the surfaces having contact with a liquid crystal layer.

FIG. 15B is a cross-sectional views of a liquid crystal panel showing the liquid crystal alignment direction when no drive voltage is applied in the liquid crystal panel including a protrusion formed on one surface having contact with a liquid crystal layer and a recess formed in the other surface having contact with the liquid crystal layer.

FIG. 16 is an external perspective view showing a large liquid crystal television as an example of an electronic device.

### DESCRIPTION OF EXEMPLARY EMBODIMENTS

Embodiments of a liquid crystal display, which is an example of a liquid crystal device according to the invention, and an electronic device having the liquid crystal display will now be described with reference to the accompanying drawings. A liquid crystal display will be described with examples of a color filter substrate on which an alignment layer for vertical alignment is to be provided and a liquid crystal display based on a multi-domain vertical alignment (MVA) method using the color filter substrate. Additionally, in the drawings to be referred to in the following description, the scales of the respective members and layers are changed appropriately for easier recognition.

### First Embodiment

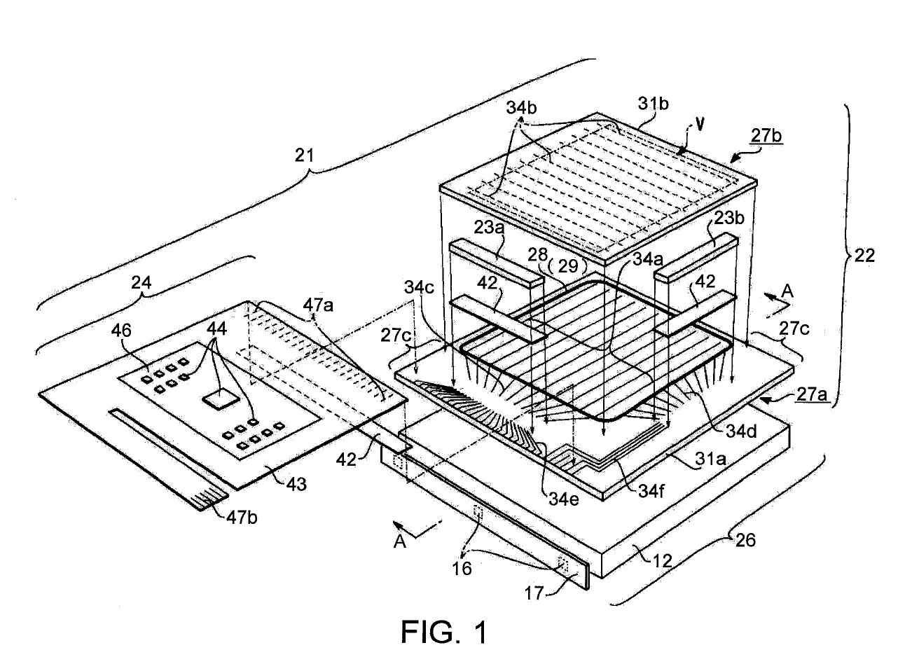

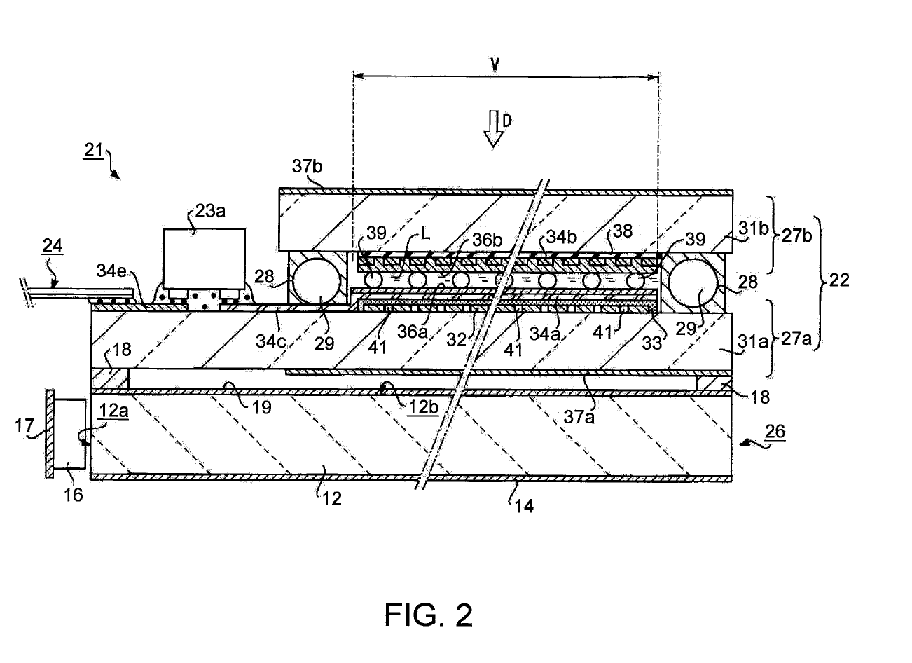

First, the configuration of a liquid crystal display will be described. FIG. 1 is an exploded perspective view of a liquid crystal display according to a first embodiment of the invention. FIG. 2 is a cross-sectional view of the liquid crystal display taken along the line A-A in FIG. 1. In FIG. 1, a liquid crystal display 21 is formed by mounting liquid crystal driver ICs 23a and 23b as semiconductor chips on a liquid crystal panel 22, coupling a flexible printed circuit (FPC) 24 as a wiring coupler to the liquid crystal panel 22, and providing a lighting device 26 as a backlight on the back of the liquid crystal panel 22.

The liquid crystal panel 22 is formed by bonding a first substrate 27a and a second substrate 27b through a sealant 28. The sealant 28 is formed by, for example, applying an epoxy-based resin on the inner surface of the first substrate 27a or the second substrate 27b in a circular shape by means of screen printing or the like. Further, in the sealant 28, conductors 29 (see FIG. 2) formed of a conductive material into a spherical or cylindrical shape are scattered.

In FIG. 2, the first substrate 27a has a sheet-type base material 31a formed of transparent glass, transparent plastic, or the like. On the inner surface (upper surface in FIG. 2) of the base material 31a are sequentially formed a reflective layer 32, an insulating layer 33, first electrodes 34a in a stripe pattern when viewed from the direction of an arrow D (see FIG. 1), and an alignment layer 36a. Further, on the outer surface (lower surface in FIG. 2) of the base material 31a is provided a polarizing plate 37a by pasting or the like.

In FIG. 1, the space between the first electrodes 34a is illustrated far wider than the actual width for easier understanding of their arrangement. Although there are fewer first electrodes 34a, a more number of first electrodes 34a are actually formed on the base material 31a than illustrated in FIG. 1. The first substrate 27a is equivalent to an electrode substrate or an opposing substrate.

In FIG. 2, the second substrate 27b has a sheet-type base material 31b formed of transparent glass, transparent plastic, or the like. On the inner surface (lower surface in FIG. 2) of the base material 31b are sequentially formed a color filter 38, second electrodes 34b in a stripe pattern orthogonally to the first electrodes 34a when viewed from the direction of the arrow D (see FIG. 1), and an alignment layer 36b. Further, on the outer surface (upper surface in FIG. 2) of the base material 31b is provided a polarizing plate 37b by pasting or the like.

In FIG. 1, the space between the second electrodes 34b is illustrated far wider than the actual width, as in the case of the first electrodes 34a, for easier understanding of their arrangement. Although there are fewer second electrodes 34b, a more number of second electrodes 34b are actually formed on the base material 31b than illustrated in FIG. 1. The second substrate 27b is equivalent to an opposing substrate or an electrode substrate.

In FIG. 2, liquid crystal L is encapsulated in the space, i.e., a cell gap, surrounded by the first substrate 27a, the second substrate 27b, and the sealant 28. On the inner surface of the first substrate 27a or the second substrate 27b are scattered a number of fine, spherical spacers 39, the presence of which in the cell gap maintains the cell gap at a uniform thickness.

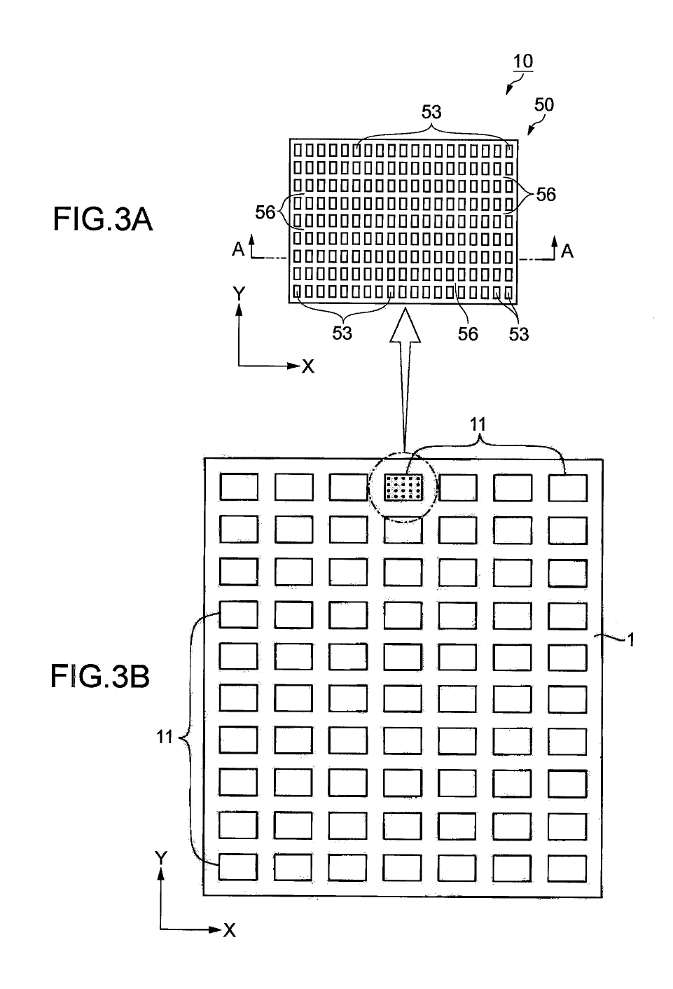

The intersections of the first electrodes 34a and the second electrodes 34b, which are positioned orthogonally to each other, are in a dot-matrix pattern when viewed from the direction of the arrow D in FIG. 2. Each of the intersections in the dot matrix configures a single pixel. On a color filter 38, color element regions (see FIG. 3) are so formed that one color element 53 (see FIG. 3) is positioned over one pixel. For example, a color filter having the three primary colors is formed by arranging each of red (R), green (G), and blue (B) colors into a predetermined pattern, such as a stripe pattern, a delta pattern, a mosaic pattern, or the like, when viewed from the arrow-D direction. The one pixel mentioned above corresponds to each of the color elements 53 for R, G, and B. A group of three pixels consisting of the respective pixels for R, G, and B configures the minimum unit (hereinafter referred to as “picture element”) for configuring an image.

By selectively causing a plurality of pixels arranged in a dot-matrix pattern, i.e., a picture element, to emit light, images such as characters, numbers, etc. are displayed on the outer surface of the second substrate 27b of the liquid crystal panel 22. A region where an image is displayed in this manner is an effective pixel region, and a flat rectangular region indicated by an arrow V in FIGS. 1 and 2 is an effective display region.

In FIG. 2, the reflective layer 32 is formed of a light-reflecting material such as an APC alloy, aluminum (Al), or the like, and apertures 41 are formed in positions corresponding to the respective pixels, i.e., the intersections of the first and second electrodes 34a and 34b. Consequently, the apertures 41 are arranged in a dot-matrix pattern when viewed from the arrow-D direction in FIG. 2, as in the case of pixels.

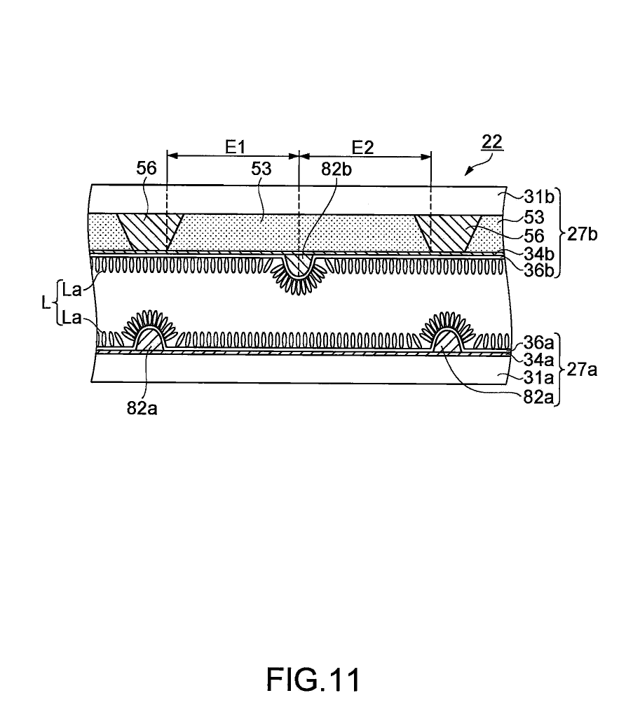

The first and second electrodes 34a and 34b are made of a conductive material such as indium tin oxide (ITO), indium zinc oxide (IZO), or the like and so deposited as to have a certain level of electric resistance and transparency. The thickness is approximately 0.1 μm. Further, the alignment layers 36a and 36b are formed by applying a polyimide-based resin to form a film having a uniform thickness. With the presence of the alignment layers 36a and 36b, when no voltage is applied between the first and second electrodes 34a and 34b in a liquid crystal display based on an MVA method, liquid crystal molecules La (see FIG. 11) of the liquid crystal L are aligned almost vertically to the alignment layer 36a or 36b. In other words, the liquid crystal molecules La are aligned almost vertically to the surfaces of the first and second substrates 27a and 27b.

In FIG. 1, the first substrate 27a is formed larger than the second substrate 27b. Therefore, when these substrates are bonded together with the sealant 28, part of the first substrate 27a extends beyond the second substrate 27b, which is a substrate extension 27c. Further, on the substrate extension 27c, various kinds of wiring such as lead-out wiring 34c extending from the first electrodes 34a, lead-out wiring 34d conductive to the second electrodes 34b on the second substrate 27b through the conductors 29 (see FIG. 2) in the sealant 28, metal wiring 34e coupled to an input bump, i.e., an input terminal, of the liquid crystal driver IC 23a, metal wiring 34f coupled to an input bump of the liquid crystal driver IC 23b, etc. are formed in appropriate patterns.

In the first embodiment, the lead-out wiring 34c extending from the first electrodes 34a and the lead-out wiring 34d conductive to the second electrodes 34b are formed of ITO, i.e., a conductive oxide, the same material as those of their electrodes. Further, the metal wiring 34e and 34f, which are the wiring for the input of the liquid crystal driver ICs 23a and 23b, are formed of a metal material having a low electric resistance, such as an APC alloy for example. An APC alloy, which mainly contains Ag, is an alloy additionally containing Pd and Cu at the proportion of, for example, 98% for Ag, 1% for Pd, and 1% for Cu.

The liquid crystal driver ICs 23a and 23b are adhesively mounted on the surface of the substrate extension 27c through an anisotropic conductive film (ACF) 42. This means that the first embodiment is a so-called chip-on-glass (COG) liquid crystal panel in which a semiconductor chip is directly mounted on a substrate. In such a COG mounting configuration, with the aid of conductive particles contained in the ACF 42, the input bumps of the liquid crystal driver ICs 23a and 23b are conductively coupled with the metal wiring 34e and 34f, and the output bumps of the liquid crystal driver ICs 23a and 23b are conductively coupled with the lead-out wiring 34c and 34d.

In FIG. 1, the FPC 24 has a flexible resin film 43, a circuit 46 including chips 44, and metal wiring terminals 47a. The circuit 46 is directly mounted on the surface of the resin film 43 by means of a conductive coupling technique such as soldering or the like. Further, the metal wiring terminals 47a are formed of a conductive material such as an APC alloy, Cr, Cu, or the like. The portion of the FPC 24 where the metal wiring terminals 47a are formed is coupled to the portion of the first substrate 27a where the metal wiring 34e and 34f are formed through the ACF 42. Further, with the aid of conductive particles contained in the ACF 42, the metal wiring 34e and 34f on the substrate and the metal wiring terminals 47a on the FPC 24 come into conduction with each other.

On an end of the other side of the FPC 24, external coupling terminals 47b are formed to be coupled to an external circuit, which is not shown. According to a signal transmitted from the external circuit, the liquid crystal driver ICs 23a and 23b are driven to provide a scanning signal to either the first electrodes 34a or the second electrodes 34b and a data signal to the other. Thus, the voltage is controlled individually for each of the pixels arranged in a dot-matrix pattern in the effective display region V, and consequently the alignment direction of the liquid crystal L is controlled for each pixel.

The lighting device 26 in FIG. 1, which functions as a so-called backlight, includes a light guide 12 formed of an acrylic resin or the like, a diffusing sheet 19 provided on a light-emerging surface 12b of the light guide 12, a reflecting sheet 14 provided on the surface opposite the light-emerging surface 12b of the light guide 12, and a light-emitting diode (LED) 16 as a light source, as shown in FIG. 2.

The LED 16 is supported by an LED substrate 17, which is mounted to, for example, a support (not shown) integrally formed with the light guide 12. With the LED substrate 17 mounted to a predetermined position of the support, the LED 16 is positioned to face a light-guiding surface 12a, which is the side surface of the light guide 12. In addition, a reference numeral 18 represents a buffer material for buffering the impact to the liquid crystal panel 22.

As the LED 16 emits light, the light is taken from the light-guiding surface 12a, guided into the light guide 12, and, while being propagated by reflecting on the reflecting sheet 14 and the walls of the light guide 12, emerges outside as a flat light from the light-emerging surface 12b through the diffusing sheet 19.

Since the liquid crystal display 21 of the first embodiment is configured as above, when the brightness of the external light such as sunlight, ambient light, or the like is sufficient, the external light is taken from the second substrate 27b into the liquid crystal panel 22, passes through the liquid crystal L, reflects on the reflective layer 32, and is provided again to the liquid crystal L. The alignment direction of the liquid crystal L is controlled for each pixel with a voltage applied between the first and second electrodes 34a and 34b sandwiching the liquid crystal L. Hence, the transmittance of the light provided to the liquid crystal L is controlled for each pixel. The color of a picture element which are viewed from the outside of the liquid crystal panel 22 is created according to the brightness of the respective pixels for R, G, and B configuring one picture element. With combinations of the picture elements, images such as characters, numbers, etc. are displayed outside the liquid crystal panel 22. In this manner, reflective display is performed.

On the other hand, when the brightness of the external light is insufficient, light is emitted by the LED 16, emerged as a flat light from the light-emerging surface 12b of the light guide 12, and provided to the liquid crystal L through the apertures 41 formed in the reflective layer 32. In this case, the provided light is transmitted at transmittances for the respective picture elements through the liquid crystal L having its alignment direction controlled, as in the case of reflective display. In this manner, transmissive display is performed.

Next, the configurations of color filters such as the color filter 38 formed on the second substrate 27b will be described. FIG. 3A is a schematic plan view showing the configuration of an example color filter. Further, FIG. 3B is a schematic plan view showing the configuration of a mother substrate on which a plurality of the second substrates are formed.

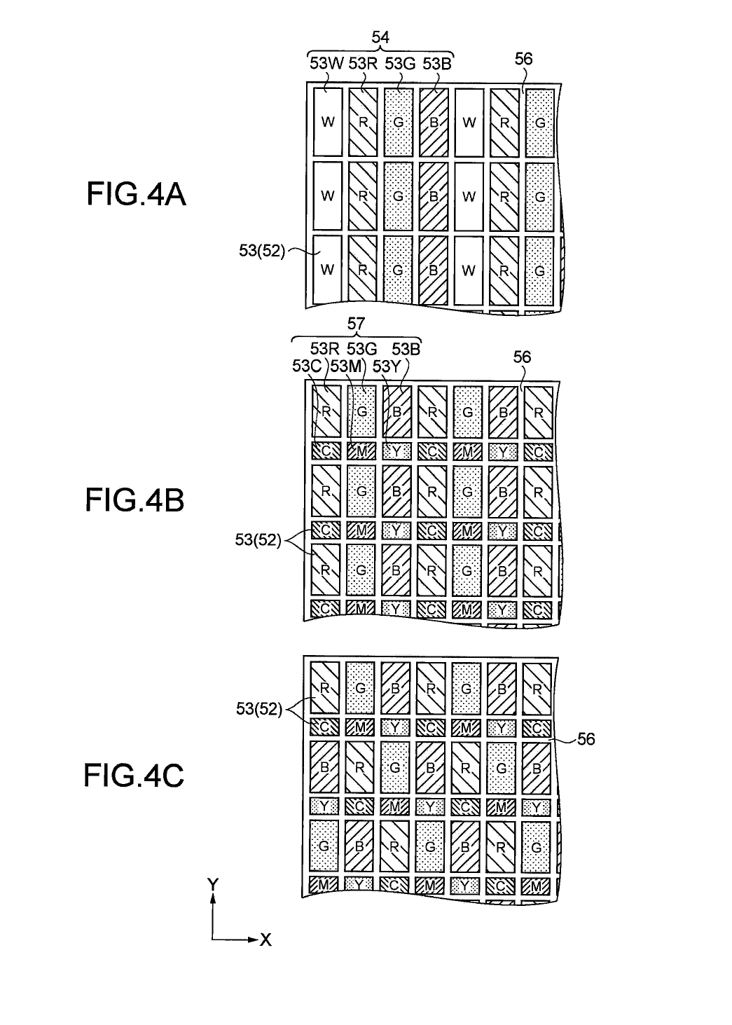

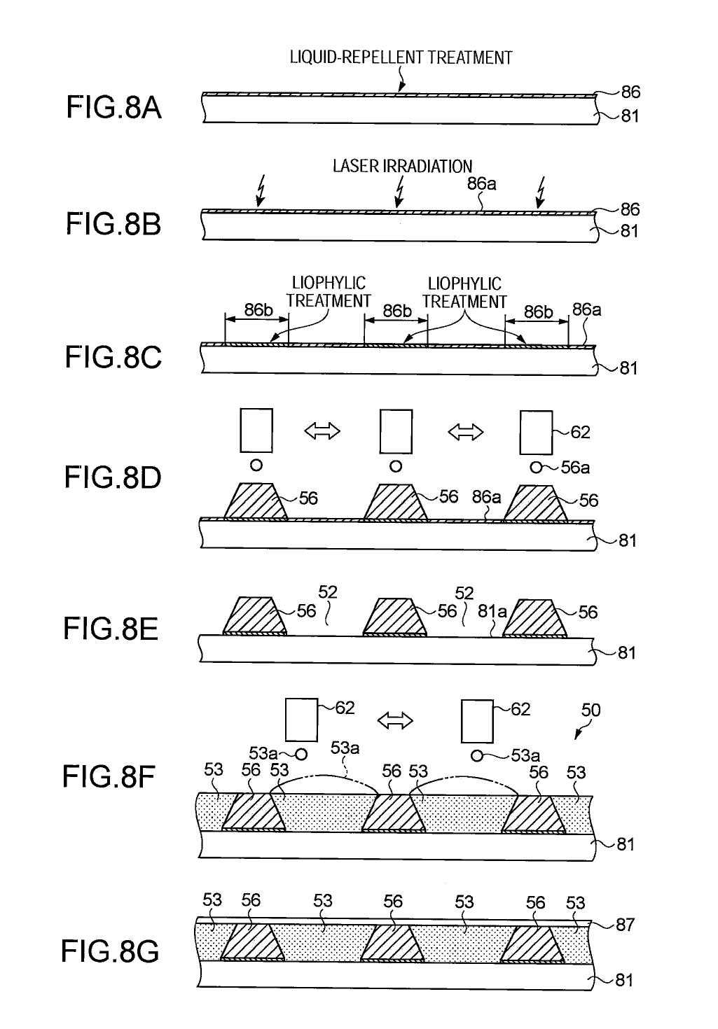

A color filter 50 is formed by forming a plurality of color element regions 52 (see FIGS. 4 and 8E) on the surface of a rectangular substrate made of glass, plastic, or the like in a dot pattern, i.e., a dot-matrix pattern in the first embodiment, forming the color elements 53 in the color element regions 52, and forming a protection layer over the color elements 53. In addition, FIG. 3A shows a plan view of the color filter 50 without the protection layer.

A rectangular color filter substrate 10 on which the color filter 50 is formed is cut out of, for example, the mother substrate 1 having a large area as shown in FIG. 3B. More specifically, a pattern for one color filter 50 is formed in each of a plurality of color filter-forming regions 11 defined on the mother substrate 1, and grooves for cutout are formed around the color filter-forming regions 11. Further, by cutting the mother substrate 1 along the grooves, the rectangular color filter substrates 10 having a color filter 50 are formed.

Next, the arrangement of color elements will be described. The color elements 53 are formed by feeding coloring materials into the plurality of, for example, rectangular color element regions 52 arranged in a dot-matrix pattern with partitions 56 formed of a non-transmissive resin material into a lattice shape. FIGS. 4A to 4C are plan views showing examples of color element arrangement. FIG. 4A shows an example arrangement of a four-color filter, and FIGS. 4B and 4C show example arrangements of a six-color filter. There are known arrangements such as stripe arrangement, mosaic arrangement, delta arrangement, etc. In a stripe arrangement, the color elements 53 have the same color for the respective columns of the matrix. In a mosaic arrangement, colors are alternated in the horizontal direction by one color element 53 per row. In the case of a three-color filter, any three color elements 53 vertically or horizontally lined up in series are of three different colors. In a delta arrangement, the rows of the color elements 53 are staggered. In the case of a three-color filter, any three adjacent color elements 53 are of different colors.

In a four-color filter shown in FIG. 4A, each color element 53 is formed of a coloring material having any color of red (R), green (G), blue (B), and water-clear (W). A group of adjacent color elements including 53R, 53G, 53B, and 53W for red (R), green (G), blue (B), and water-clear (W) one each forms a filter of a picture element (hereinafter referred to as “picture element filter”), which is the minimum unit for configuring an image. By selectively transilluminating any one or combination of the color elements 53R, 53G, 53B, and 53W in one picture element filter, full-color display is performed. In this case, the partitions 56 formed of a non-transmissive resin material functions as a black matrix. In the four-color filter shown in FIG. 4A, the picture element filters 54 are arranged in a stripe pattern.

In a six-color filter shown in FIG. 4B, each color element 53 is formed of a coloring material having any color of red (R), green (G), blue (B), cyan (C or blue-green), magenta (M or purple-red), and yellow (Y). A group of adjacent color elements including 53R, 53G, 53B, 53C, 53M, and 53Y for red (R), green (G), blue (B), cyan (C), magenta (M), and yellow (Y) one each forms a picture element filter 57 which corresponds to one picture element. The color elements are so arranged that the three primary colors of light including red (R), green (G), and blue (B) are horizontally (in the X-direction in FIG. 4B) lined up with cyan (C), magenta (M), and yellow (Y), which are the complementary colors of red (R), green (G), and blue (B), positioned adjacent to the colors of red (R), green (G), and blue (B) according to their complementary relationship. By selectively transilluminating any one or combination of the color elements 53R, 53G, 53B, 53C, 53M, and 53Y in one picture element filter, full-color display is performed. In the six-color filter shown in FIG. 4B, the picture element filters 57 are arranged in a stripe pattern. In the six-color filter shown in FIG. 4C, the picture element filters 57 are arranged in a mosaic pattern.

In the six-color filter shown in FIG. 4B or 4C, the color elements 53C, 53M, and 53Y for cyan (C), magenta (M), and yellow (Y), the complementary colors of the three primary colors of light including red (R), green (G), and blue (B), have smaller areas than those of the color elements 53R, 53G, and 53B for red (R), green (G), and blue (B). This area difference of the color elements 53 is for compensating the brightness of the emitted light which differs depending on the color elements even though emitted from the same light source. The dimensions of one color element 53 are 30 μm×100 μm or 30 μm×60 μm and 30 μm×20 μm, for example. Further, the distance between the color elements 53, that is, the pitch between elements, is 45 μm, for example.

Next, a droplet ejection method used for forming a color filter such as the above color filter 50 will be described. As the ejection technique for droplet ejection, the charge control method, the pressurized vibration method, the electromechanical conversion method, the electrothermal conversion method, the electrostatic attraction method, etc. can be named. In the charge control method, a material is ejected from an ejection nozzle by putting a charge to the material using a charged electrode and controlling the direction to which the material flies using a deflecting electrode. In the pressurized vibration method, a material is ejected through the tip of an ejection nozzle by applying an ultrahigh pressure of approximately 30 kg/cm² to the material. If no control voltage is applied, the material is pushed straight and ejected from the ejection nozzle. If a control voltage is applied, the material scatters with electrostatic repulsion caused within the material and is not ejected from the ejection nozzle. In the electromechanical conversion method, which utilizes a piezoelectric element's characteristic of being deformed by an electric pulse signal, a material is ejected from an ejection nozzle by applying a pressure through a flexible substance to a space where the material is pooled by utilizing the deforming characteristic of the piezoelectric element and pushing the material out of the space.

In the electrothermal conversion method, a material is ejected under the pressure of bubbles produced by rapidly vaporizing the material into bubbles using a heater provided in a space where the material is pooled. In the electrostatic attraction method, a material is brought out of a space where the material is pooled by applying a very low pressure to the space, forming a meniscus of the material in an ejection nozzle, and applying an electrostatic attractive force. In addition to the above methods, other techniques are also applicable such as a method to utilize the change of fluid viscosity due to an electric field, a method to eject a material by utilizing discharge sparks, etc. The droplet ejection method has an advantage that a material can be placed precisely in a desired position in a desired amount with less waste of the material. Especially, the piezoelectric method is advantageous in that, for example, there is no influence on the composition, etc. of a liquid material because no heat is applied to the material. In the first embodiment, the piezoelectric method is employed considering its high degree of freedom in the choice of a liquid material and high droplet controllability.

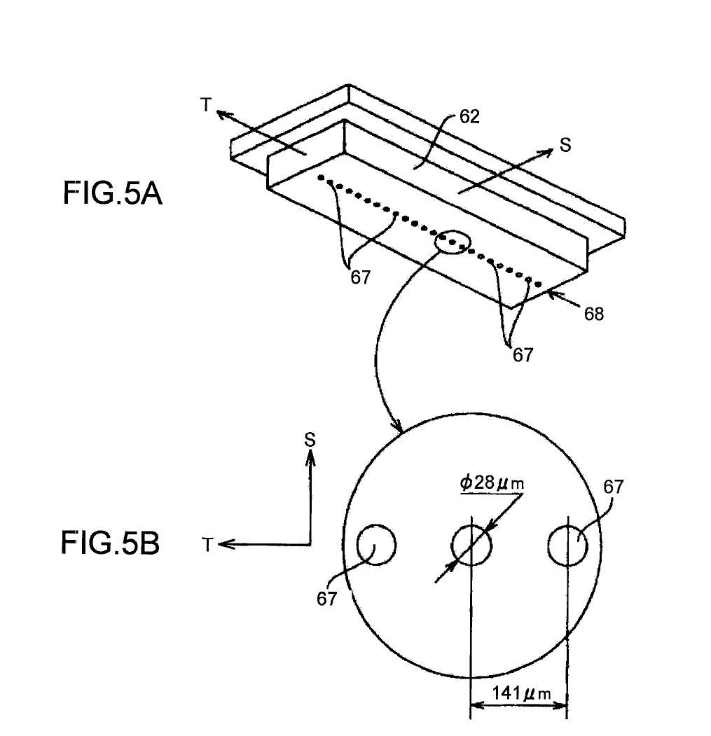

Next, a droplet ejection head of a device-manufacturing apparatus used for manufacturing a device according to the first embodiment of the invention by a droplet ejection method will be described. This device-manufacturing apparatus is a droplet ejection apparatus (inkjet apparatus) for manufacturing a device by ejecting (dropping) droplets from a droplet ejection head to a substrate. FIGS. 5A and 5B are schematic diagrams showing external appearances of a droplet ejection head. FIG. 5A is a schematic perspective view showing an external appearance of a droplet ejection head, and FIG. 5B is a diagram showing a nozzle arrangement. As shown in FIG. 5A, a droplet ejection head 62 has, for example, a line of nozzles 68 having a plurality of ejection nozzles 67 formed in a line. The number of the ejection nozzles 67 is 180, for example, the aperture of each ejection nozzle 67 is 28 μm, for example, and the pitch between the ejection nozzles 67 is 141 μm, for example (see FIG. 5B). A reference direction S shown in FIG. 5A indicates the main scanning direction along which the droplet ejection head 62 moves relatively to a substrate to allow droplets to land on any position on the substrate, and a lining direction T indicates the direction along which the ejection nozzles 67 are provided as the line of nozzles 68.

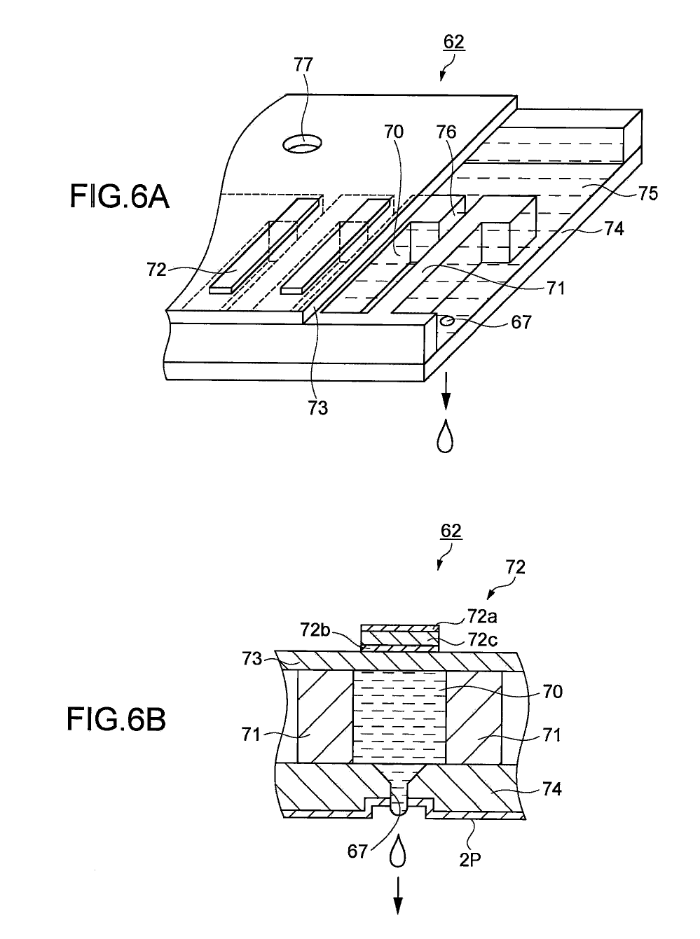

FIG. 6A is a perspective view showing the configuration of a droplet ejection head, and FIG. 6B is a cross-sectional view showing the detailed configuration of an ejection nozzle of the droplet ejection head. As shown in FIGS. 6A and 6B, each droplet ejection head 62 has a vibrating plate 73 and a nozzle plate 74. Between the vibrating plate 73 and the nozzle plate 74 is a liquid pool 75 which is always filled with a material liquid to be supplied from a liquid material tank (omitted in the figure) through an aperture 77. There are also a plurality of head partitions 71 between the vibrating plate 73 and the nozzle plate 74. Further, the space enclosed by the vibrating plate 73, the nozzle plate 74, and a pair of the head partitions 71 is a cavity 70. Since the cavities 70 are provided correspondingly to the ejection nozzles 67, the number of the cavities 70 is the same as that of the ejection nozzles 67. The material liquid is supplied from the liquid pool 75 to each cavity 70 through a supply port 76 positioned between each pair of the head partitions 71.

On the vibrating plate 73 are oscillators 72 positioned correspondingly to the cavities 70. Each of the oscillators 72 consists of a piezoelectric element 72c and a pair of electrodes 72a and 72b sandwiching the piezoelectric element 72c. By applying a drive voltage to the pair of electrodes 72a and 72b, a liquid material is ejected from the corresponding ejection nozzle 67 in the form of droplets. To control the adhesion of some of the liquid material ejected from the ejection nozzle 67 to the nozzle plate 74, a liquid-repellent treatment layer 2P having repellency to the liquid material is formed on the external surface of the nozzle plate 74.

A controller (omitted in the figure) controls liquid material ejection for each of the plurality of ejection nozzles 67 by controlling the voltage, i.e., a drive signal, applied to the piezoelectric element 72c. More specifically, the controller can change the volume of a droplet to be ejected from the ejection nozzle 67, the number of droplets ejected per unit time, the distance between droplets landed on the substrate, etc. For example, by selectively using the ejection nozzles 67 in the line of ejection nozzles 68 to eject droplets, a plurality of droplets can be ejected simultaneously along the lining direction T within the length of the line of nozzles 68 at the pitch intervals of the ejection nozzles 67. Along the reference direction S, the distance between droplets landed on the substrate can be changed individually for each ejection nozzle 67 from which droplets are to be ejected. In addition, the volume of a droplet to be ejected from each ejection nozzle 67 can be varied within 1 to 300 pl (picoliter).

Method of Manufacturing Color Filter Substrate

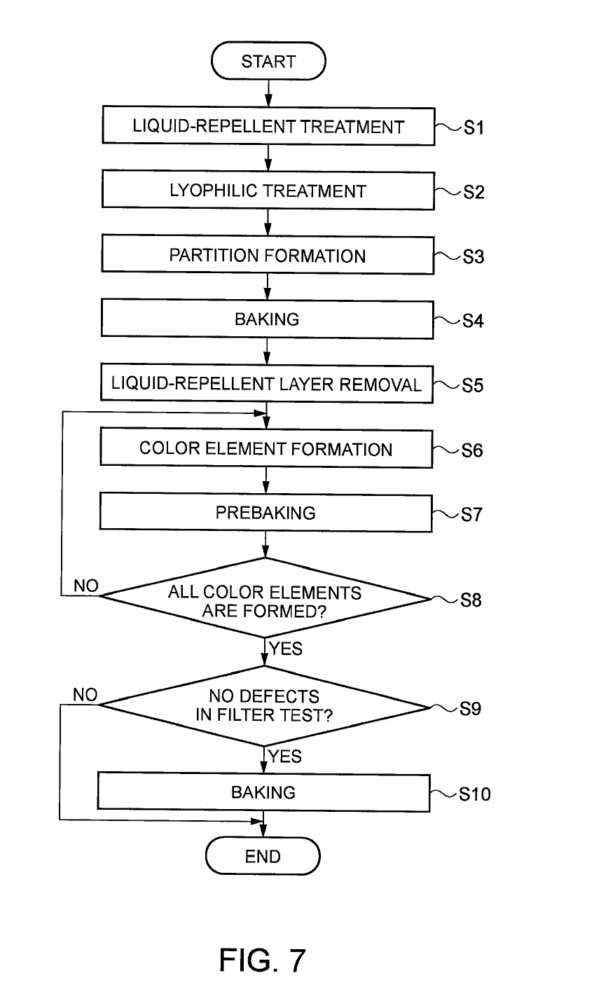

Next, a process of manufacturing a color filter substrate will be described with reference to FIGS. 7 and 8A to 8G. FIG. 7 is a flow chart showing the steps of manufacturing a color filter substrate, and FIGS. 8A to 8G are schematic cross-sectional views showing the steps of manufacturing a color filter substrate.

As shown in FIG. 7, a method of manufacturing the color filter substrate 10 according to the first embodiment includes a liquid-repellent treatment step (step S1) in which the surface of a glass substrate 81 (the mother substrate 1: see FIG. 3B) is finished to be liquid-repellent and a lyophilic treatment step (step S2) in which the regions of the liquid-repellent surface of the glass substrate 81 corresponding to the regions for forming the partitions 56 are finished to be liquid-affinitive. The method further includes a step (step S3) for forming partitions on the glass substrate 81 in such a way to form a plurality of sections as the color element regions 52 and a step (step S6) for forming a plural kinds of color elements 53 by ejecting functional fluids containing different materials for forming color elements to the plurality of color element regions 52.

The step S1 in FIG. 7 is the liquid-repellent treatment step. In the step S1, a thin film 86 is formed on the glass substrate 81, to which liquid repellency is given, as shown in FIG. 8A. The thin film 86 is formed nearly as a monolayer by using a liquid-repellent material such as alkylsilane fluoride (FAS) or hexamethyldisilane (HMDS). More specifically, a method of forming a self-assembled layer on the surface of the glass substrate 81 or the like can be employed.

In the method of forming a self-assembled layer, a self-assembled layer configured of such as an organic molecular layer is formed on the glass substrate 81. An organic molecular layer includes a functional group bondable to the glass substrate 81, another functional group on the opposite side of the former as a liquid-repellent group which modifies surface characteristics, i.e., controls surface energy, and a carbon straight chain or a partially branching carbon chain which bonds the functional groups together. The organic molecular layer bonds to the glass substrate 81, assembles by itself, and forms a molecular layer such as a monolayer, for example.

In this case, the self-assembled layer is formed by aligning a compound which consists of a bondable functional group reactive with constituent atoms of the underlayer, etc. of the glass substrate 81 and the other straight-chain molecules and has an ultrahigh aligning characteristic because of the interaction between the straight-chain molecules. Since this self-assembled layer is formed by aligning unimolecules, the thickness of the layer can be made extremely thin and uniform on the molecular scale. In other words, with the same molecules on the layer surface, a uniform and excellent liquid repellency can be given to the layer surface.

By using fluoroalkylsilane, for example, as the highly aligning compound, each compound is aligned with a fluoroalkyl group positioned at the top of the layer to form a self-assembled layer, which gives a uniform liquid repellency to the layer surface. As the compound for forming the self-assembled layer, the following types of fluoroalkylsilane (hereinafter referred to as “FAS”) can be named: heptadecafluoro-1,1,2,2-tetrahydrodecyltriethoxysilane, heptadecafluoro-1,1,2,2-tetrahydrodecyltrimethoxysilane, heptadecafluoro-1,1,2,2-tetrahydrodecyltrichlorosilane, tridecafluoro-1,1,2,2-tetrahydrooctyltriethoxysilane, tridecafluoro-1,1,2,2-tetrahydrooctyltrimethoxysilane, tridecafluoro-1,1,2,2-tetrahydrooctyltrichlorosilane, trifluoropropyltrimethoxysilane, etc. These compounds may be used solely or as a combination of two or more. In addition, by using FAS, adhesiveness to the glass substrate 81 and preferable liquid repellency can be obtained.

Generally, FAS is expressed in a structural formula RnSiX(4-n). In this formula, n represents an integer of 1 or larger and 3 or smaller, X represents a hydrolyzable group such as a methoxy group, an ethoxy group, a halogen atom, or the like, R represents a fluoroalkyl group having a structure of (CF3)(CF2)x(CH2)y (where x represents an integer of 0 or larger and 10 or smaller and y represents an integer of 0 or larger and 4 or smaller), and if a plurality of Rs or Xs are bonded to Si, all of the Rs or Xs may be either the same or different. The hydrolyzable group represented by X forms silanol by hydrolysis and reacts with the hydroxyl group in the underlayer of the glass substrate 81 to bond to the glass substrate 81 in siloxane bonding. On the other hand, R having a fluoro group such as (CF2), etc. on the surface modifies the surface of the underlayer of the glass substrate 81 into a liquid-repellent surface (having low surface energy).

A self-assembled layer configured of an organic molecular layer or the like is formed on the glass substrate 81 by putting the above material compound and the glass substrate 81 together in an airtight container and leaving them for approximately two to three days at room temperature or keeping the temperature of the airtight container entirely at 100° C. for approximately three hours. Although a material in a gas phase is used in the above method, a self-assembled layer can also be formed using a material in a liquid phase. For example, a self-assembled layer can be formed on the glass substrate 81 by dipping the glass substrate 81 into a solution containing a material compound followed by cleaning and drying. In addition, it is desirable to perform a pretreatment of the surface of the glass substrate 81 before forming a self-assembled layer by irradiating the glass substrate 81 with an ultraviolet radiation or cleaning the glass substrate 81 with a solvent.

The step S2 in FIG. 7 is a lyophilic treatment step. In the step S2, liquid affinity is given to a surface 86a subjected to the liquid-repellent treatment by irradiating with a laser beam, as shown in FIG. 8B. In the portion irradiated with a laser beam, the siloxane bond is broken to create a bond to a hydroxyl group, which gives liquid affinity. In this case, the regions of laser beam irradiation are regions 86b for forming the partitions 56.

In addition, as the laser beam to be used for irradiation, one with a wavelength range to cause heat generation is desirable. For example, one with a wavelength range of infrared rays (0.7 to 10 μm) is preferable. As the source of such a laser beam, an Nd:YAG laser (1.064 μm), a CO₂ laser (10.6 μm), etc. can be used. Further, a lyophilic treatment is performed using a laser beam irradiator having the above laser beam source and a table movable at least in the X- and Y-directions by loading the glass substrate 81 on the table and irradiating with the laser beam in such a way to draw the regions 86b.

In addition, a lyophilic treatment with respect to the thin film 86 configured of FAS or the like can also be performed by another method including the steps of covering the region excluding the regions 86b to be subjected to the lyophilic treatment with a mask and irradiating with an ultraviolet radiation (UV).

The step S3 in FIG. 7 is a partition formation step. In the step S3, the partitions 56 are formed using the droplet ejection head 62 (see FIGS. 5A to 6B) as shown in FIG. 8D. As described above, the droplet ejection head 62, which can eject a liquid material from the nozzles in the form of droplets, forms the partitions 56 by ejecting a functional fluid 56a containing a partition-forming material in the state of fluid.

More specifically, the droplet ejection head 62 is so positioned sequentially as to come opposite to each of the regions 86b for forming the partitions 56 and caused to eject the functional fluid 56a as droplets to land and spread in each region 86b. By repeating the step of drying the ejected functional fluid 56a, the functional fluid 56a is deposited to form the partitions 56. In this case, the height of the partitions 56 is approximately 1.5 μm, for example. In addition, a solution containing a phenol-based resin or the like as a partition-forming material can be used as the functional fluid 56a.

In a step S4, the partitions 56 formed as above are baked. In a step S5, the remaining thin film 86 on the glass substrate 81 having the partitions 56 is removed, as shown in FIG. 8E. The thin film 86 is a monolayer configured of FAS or the like and can be removed by heating the glass substrate 81 up to approximately 300° C. to be sublimed. Further, a lyophilic treatment may be performed with respect to a post-removal surface 81a of the glass substrate 81. In addition, the thin film 86 can also be removed by other methods than heating, such as UV irradiation, O2 plasma processing, etc. The steps S4 and S5 can be performed simultaneously by heating the entire glass substrate 81.

The step S6 in FIG. 7 is a color element formation step. In the step S6, the color elements 53 are formed by ejecting a functional fluid 53a containing a color element-forming material to each of the color element regions 52 sectioned by the partitions 56 from the droplet ejection head 62 in the form of droplets and drying the droplets, as shown in FIG. 8F. In this case, the number of ejections of the functional fluid 53a is so adjusted for each color element region that the thickness of the dried color elements 53 will be almost the same as the height (approximately 1.5 μm) of the partitions 56. Needless to say, different functional fluids 53a containing different color element materials are ejected correspondingly to the color element regions 52 for forming the color elements 53 of different colors. For example, in the case of the above-described six-color filter (see FIGS. 4B and 4C), six kinds of functional fluids 53a containing different color element materials are sequentially supplied to the droplet ejection head 62 and ejected correspondingly to the color element regions 52 for forming the color elements 53R, 53G, 53B, 53C, 53M, and 53Y having different colors. Alternatively, a plurality of the droplet ejection heads 62 may be prepared so that the functional fluids 53a containing different color element materials can be separately supplied to and ejected from each of the droplet ejection heads 62.

In a step S7, the functional fluids 53a ejected toward and positioned in the color element regions 52 are temporarily solidified or hardened by drying or prebaking at a low temperature (60° C. for example).

In a step S8, whether or not the ejection and prebaking of the functional fluids 53a are completed for all color elements is judged. If the ejection and prebaking of the functional fluids 53a are not completed for all color elements (NO in the step S8), the process returns to the step S6 and the ejection of the functional fluids 53a toward the color element regions 52 (step S6) and the prebaking of the functional fluids 53a positioned in the color element regions 52 (step S7) are reperformed. If the ejection and prebaking of the functional fluids 53a are completed for all colors (YES in the step S8), the process proceeds to a step S9. In addition, the above steps may be performed in either way: the ejection of the functional fluid 53a toward the color element regions 52 (step S6) and the prebaking of the functional fluid 53a positioned in the color element regions 52 (step S7) are performed as a set for each individual color element, or the ejection of the functional fluids 53a toward the color element regions 52 (step S6) is performed first for all colors and then the prebaking of the color elements 53 (step S7) is performed simultaneously for all colors.

In the step S9, the color filter substrate 10 configured as above is tested to check the presence of a defect. This test is performed by observing the partitions 56 and the color elements 53 with, for example, the naked eye, a microscope, or the like. In this case, the test may be performed automatically by taking a photograph of the color filter substrate 10, which is to be the reference for judgment. The defect of the color element 53 includes a lack of the color element 53 (so-called a lack of a dot), no lack of the color element 53 but an inappropriately large or small amount (volume) of the functional fluid 53a positioned in the color element region 52, no lack of the color element 53 but a mixture or adherence of a foreign material such as dust, etc.

If a defect of the color element 53 is found in this test (NO in the step S9), the defective color filter substrate 10 is transferred to a separate step for reproducing a substrate and the process of manufacturing a color filter substrate is completed.

If no defects of the indicating material are found in the test (YES in the step S9), the process proceeds to a step S10. In the step S10, the prebaked color elements 53 are baked to be completely solidified or hardened. For example, by performing baking at a temperature of approximately 200° C., the color elements 53R, 53G, 53B, 53C, 53M, and 53Y on the color filter substrate 10 are completely solidified or hardened. The temperature for this baking step can be arbitrarily determined according to the compositions, etc. of the functional fluids 53a. Alternatively, without heating up to a high temperature, only drying or aging in an atmosphere (nitrogen gas, dry air, or the like) different from the normal one may be performed. Finally, a transparent protective layer 87 is formed over the color elements 53, as shown in FIG. 8G, which completes the process of manufacturing a color filter substrate.

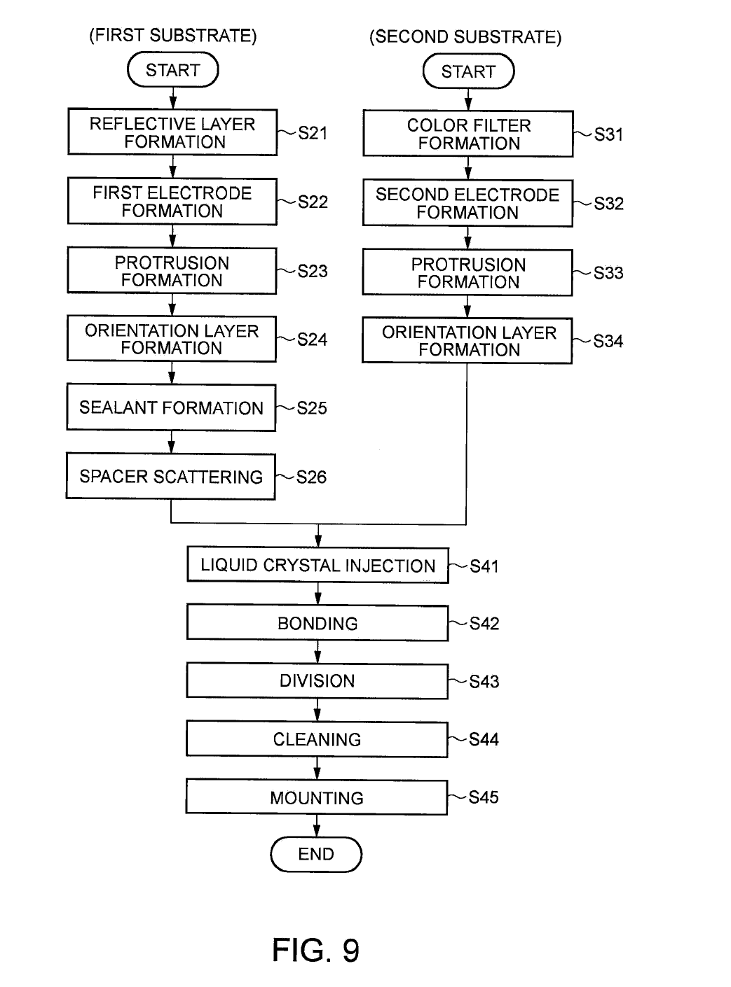

Next, a process of manufacturing a liquid crystal display will be described. The liquid crystal display 21 described with reference to FIGS. 1 and 2 is manufactured by performing manufacturing steps shown in FIG. 9, for example. FIG. 9 is a flow chart showing the steps of manufacturing a liquid crystal display. In the manufacturing steps shown in FIG. 9, a series of steps S21 to S26 is the steps of forming the first substrate 27a, and a series of steps S31 to S34 is the steps of forming the second substrate 27b. Normally, the steps of forming the first and second substrates are performed independently.

First, the steps of forming the first substrate will be described. In a step S21 in FIG. 9, the reflective layer 32 (see FIG. 2) is formed on the surface of a large mother base material substrate made of translucent glass, translucent plastic, or the like for a plural number of the liquid crystal panels 22 by means of a photolithography method or the like, on which the insulating layer 33 (see FIG. 2) is formed by means of a known deposition method.

In a step S22, the first electrodes 34a (see FIGS. 1 and 2), the lead-out wiring 34c and 34d, and the metal wiring 34e and 34f (see FIGS. 1 and 2) are formed by means of a photolithography method, the above-described droplet ejection method, or the like.

In a step S23, a protrusion 82a (see FIG. 11) which functions as an alignment-control unit is formed by means of a photolithography method, the above-described droplet ejection method, or the like.

In a step S24, the alignment layer 36a is formed over the first electrodes 34a and the protrusion 82a by means of coating, printing, or the like. With the alignment layer 36a, when no voltage is applied to the electrodes, the liquid crystal molecules La of the liquid crystal L are aligned vertically to the surface of the alignment layer 36a, that is, in a direction vertical to the displaying surface of the liquid crystal display 21 (see FIG. 11).

In a step S25, the sealant 28 is formed in a circular shape by means of, for example, screen printing or the like. In a step S26, the spherical spacers 39 are scattered in the region surrounded by the circular sealant 28. In this manner, a first large mother substrate having a plurality of panel patterns for the first substrate 27a of the liquid crystal panel 22 is formed.

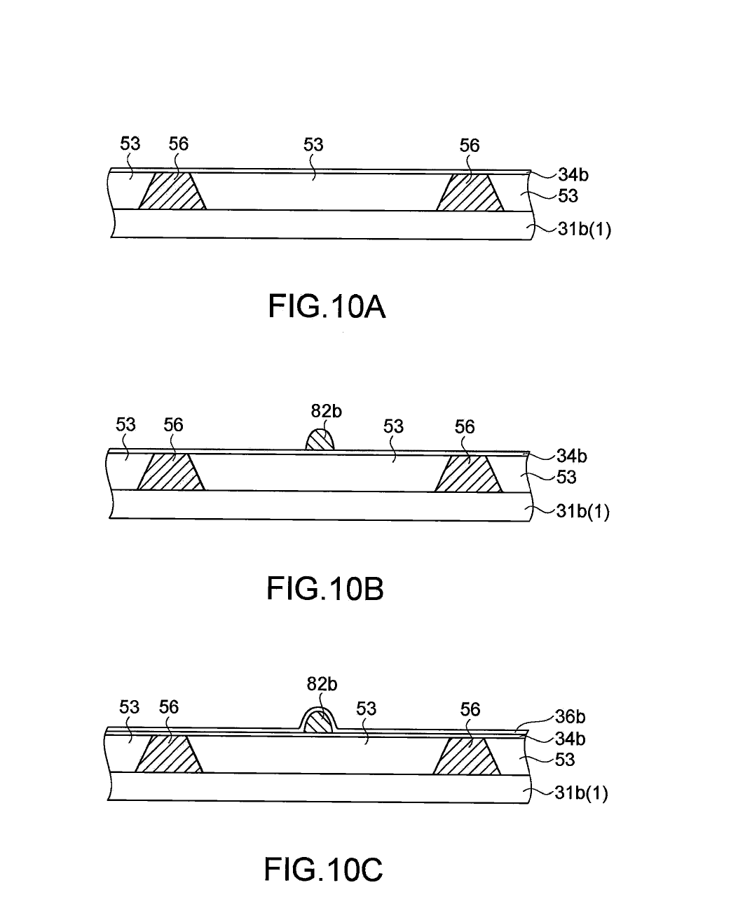

Separately from the steps of forming the first substrate, the steps of forming the second substrate are performed. FIGS. 10A to 10C are schematic cross-sectional views showing the steps of forming the second substrate. In a step S31 in FIG. 9, a large mother base material substrate made of translucent glass, translucent plastic, or the like (the mother substrate 1: see FIG. 3B) is prepared, on which the color filter 38 is formed for a plural number of the liquid crystal panels 22. The step of forming the color filter is the same as that of manufacturing the color filter substrate 10 described with reference to FIGS. 7 and 8A to 8G.

By performing the step S31, the color filter 50, i.e., the color filter 38, is formed on the mother substrate 1, i.e., the mother base material substrate, as shown in FIG. 8F. In a step S32, the second electrodes 34b shown in FIG. 10A are formed by means of a photolithography method or the like.

In a step S33, as shown in FIG. 10B, a protrusion 82b (see FIG. 11) which functions as an alignment-control unit is formed by means of a photolithography method, the above-described droplet ejection method, or the like.

In a step S34, as shown in FIG. 10C, the alignment layer 36b is formed over the second electrodes 34b and the protrusion 82b by means of coating, printing, or the like. With the alignment layer 36b, when no voltage is applied to the electrodes, the liquid crystal L is aligned vertically to the surface of the alignment layer 36b, that is, in a direction vertical to the displaying surface of the liquid crystal display 21. In this manner, a second large mother substrate having a plurality of panel patterns for the second substrate 27b of the liquid crystal panel 22 is formed.

In a step S41 following the completion of the first and second large mother substrates, an appropriate amount of the liquid crystal L is injected into the regions surrounded by the circular sealants 28 formed on the first mother substrate.

In a step S42, the first and second mother substrates are bonded together after aligning, or positioning, them with the sealant 28 in between. In this manner, a panel structure having a plurality of liquid crystal panel units is formed. Since the steps S41 and S42 are performed in nearly a vacuum, only the liquid crystal L is injected into the space enclosed by the sealant 28 between the first and second substrates without the permeation of air, etc.

In a step S43, scribing grooves, i.e., grooves for cutoff, are formed in predetermined positions of the completed panel structure and the panel structure is broken, or divided, along the scribing grooves. In this manner, a plurality of the liquid crystal panels 22 are cut out into individual pieces. In a step S44, the liquid crystal panels 22 are individually cleaned. In a step S45, the liquid crystal driver ICs 23a and 23b are mounted, the lighting device 26 is attached as a backlight, and the FPC 24 is coupled to each liquid crystal panel 22 as shown in FIG. 1. Thus, the liquid crystal display 21 to be aimed is obtained.

Next, the control of the alignment direction of the liquid crystal L with the protrusions 82a and 82b will be described. FIG. 11 is a cross-sectional view of a liquid crystal panel showing the liquid crystal alignment direction when no drive voltage is applied. As described above, the first substrate 27a includes the first electrodes 34a, the protrusion 82a, and the alignment layer 36a formed on the base material 31a. In addition, the reflective layer 32 and the insulating layer 33 are omitted in FIG. 11 because they have no influence on liquid crystal alignment direction. The second substrate 27b includes the partitions 56 and the color elements 53 on the base material 31b, and the second electrodes 34b, the protrusion 82b, and the alignment layer 36b over the partitions 56 and the color elements 53. The first and second substrates 27a and 27b are so bonded together that the alignment layers 36a and 36b face each other with a space in between, with the liquid crystal L injected into the space.

As shown in FIG. 11, in the liquid crystal panel 22 where no drive voltage is applied between the first and second electrodes 34a and 34b, the liquid crystal molecules La of the liquid crystal L are aligned vertically to the alignment layer 36a or 36b, that is, vertically to the surfaces of the base materials 31a and 31b in the flat regions of the alignment layers 36a or 36b except the regions having the protrusions 82a and 82b. Hereinafter, the direction vertical to the surfaces of the base materials 31a and 31b is referred to as “the vertical-to-panel direction” and the direction parallel to the surfaces of the base materials 31a and 31b as “the parallel-to-panel direction”. On the protrusions 82a and 82b, the liquid crystal molecules La are aligned vertically to the surface of each protrusion. The liquid crystal molecules L aligned vertically on the sides, etc. of the protrusions 82a and 82b are slanted with respect to the vertical-to-panel direction. With the liquid crystal molecules La aligned along the vertical-to-panel direction, the liquid crystal layer prevents the transmission of light.

When a predetermined drive voltage is applied between the first and second electrodes 34a and 34b, the liquid crystal molecules La fall to a direction almost vertical to the electric field direction. With the liquid crystal molecules La aligned almost along the parallel-to-panel direction, the liquid crystal layer allows the transmission of light. When the voltage applied is low and the electric field intensity is weak, the liquid crystal molecules La are aligned at angles corresponding to the electric field intensity between the vertical-to-panel direction and the parallel-to-panel direction. By adjusting this alignment angle, the amount of transmitted light and the pixel brightness are adjusted. By adjusting the brightness of each of the pixels configuring a picture element, the color of the picture element is created.

When a predetermined drive voltage is applied between the first and second electrodes 34a and 34b, the liquid crystal molecules La slanted with respect to the vertical-to-panel direction by being aligned vertically on the sides, etc. of the protrusions 82a and 82b fall to the slanted direction. Other liquid crystal molecules La adjacent to the slanted ones also fall to the same direction under the influence of the slanted ones. The liquid crystal molecules La in a region E1 in FIG. 11 all fall to one direction, and the liquid crystal molecules La in a region E2 all fall to another direction different from that for the liquid crystal molecules La in the region E1. Therefore, when a drive voltage is applied, regions having different directions for the liquid crystal molecules La to fall are formed with the protrusion 82a or 82b as dividers. This means that since each color element region 52 which are divided into a plurality of regions by the protrusion 82a or 82b and whose liquid crystal alignment direction is controlled has different viewing-angle dependencies, the viewing angle of the liquid crystal panel 22 becomes wider. The protrusion 82a or 82b is equivalent to an alignment-control unit.

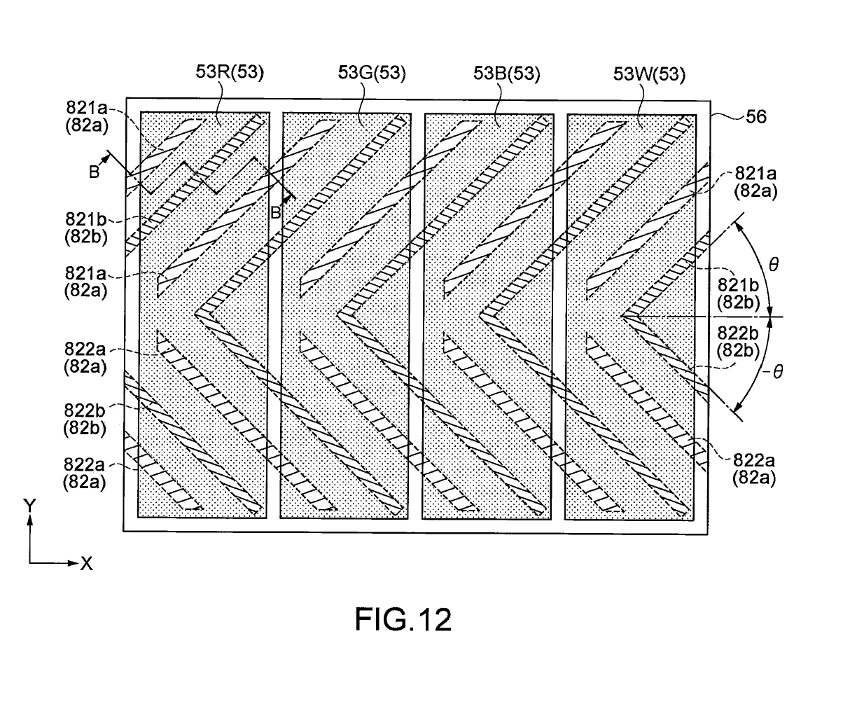

Next, how the protrusions 82a and 82b extend will be described. FIG. 12 is a plan view showing how protrusions extend in one picture element of a four-color filter. FIG. 11 described above is a cross-sectional view taken along the line B-B in FIG. 12.

As shown in FIG. 12, one picture element is configured of pixels whose corresponding color elements 53 are the color elements 53R (red), 53G (green), and 53B (blue) having red, green, and blue colors, the three primary colors of light, and a pixel whose corresponding color element 53 is the color element 53W having a water-clear color. As the protrusion 82a formed in one pixel region, there are two kinds of protrusions 821a and 822a extending along different directions. In this case, as shown in FIG. 12, the direction along which the four color elements 53 configuring one picture element including the color elements 53R, 53G, 53B, and 53W are positioned next to each other is represented as the X-direction. The protrusion 821a extends along the direction slanted by θ degrees with respect to the X-direction, and the protrusion 822a extends along the direction slanted by −θ degrees with respect to the X-direction. Likewise, as the protrusion 82b formed in one pixel region, there are two kinds of protrusions 821b and 822b extending along different directions. The protrusion 821b extends along the direction slanted by θ degrees with respect to the X-direction, and the protrusion 822b extends along the direction slanted by −θ degrees with respect to the X-direction. The direction slanted by θ degrees or −θ0 degrees with respect to the X-direction along which the protrusion 82a or 82b extends is considered as a first or second extending direction.

Regarding each of the pixels having the color elements 53R, 53G, 53B, and 53W configuring one picture element, the protrusions 821a, 822a, 821b, and 822b are formed in almost the same positions in almost the same shapes.

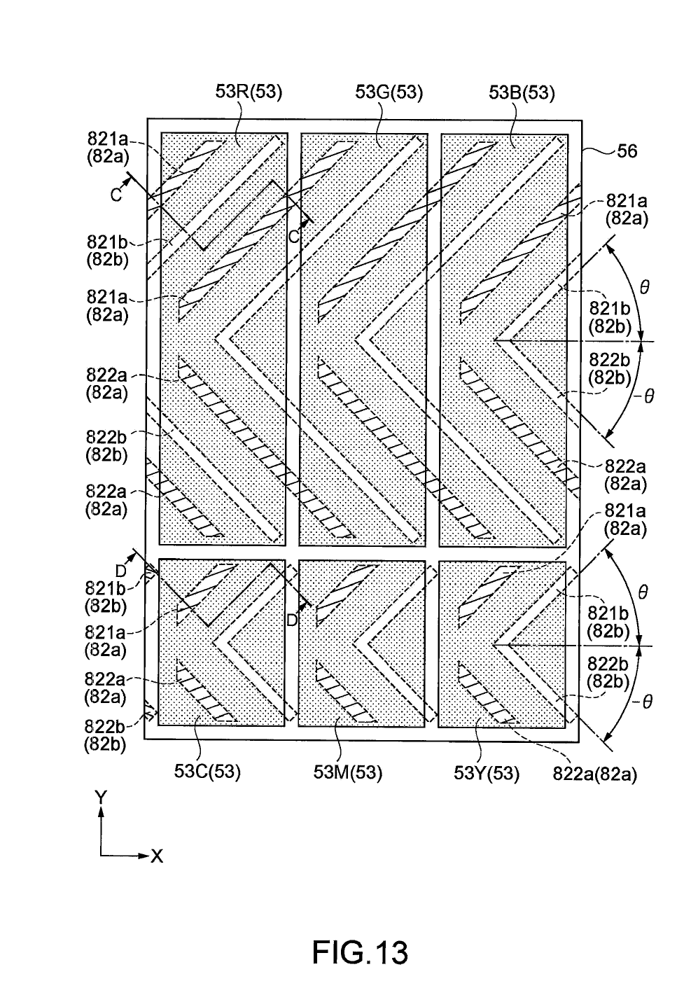

Next, an example of how the protrusions 82a and 82b of a six-color filter extend will be described. FIG. 13 is a plan view showing how protrusions extend in one picture element of a six-color filter. The shapes of the cross sections taken along the lines C-C and D-D in FIG. 13 are substantially equivalent to that of the cross section shown in FIG. 11.

As shown in FIG. 13, one picture element is configured of pixels whose corresponding color elements 53 are the color elements 53R, 53G, and 53B having the three primary colors of light and pixels whose corresponding color elements 53 are the color elements 53C, 53M, and 53Y having the complementary colors of the three primary colors of light. As the protrusion 82a formed in one pixel region, there are two kinds of protrusions 821a and 822a extending along different directions. In this case, as shown in FIG. 13, the direction along which three of the color elements 53 configuring one picture element including the color elements 53R, 53G, and 53B or the other three color elements 53 including the color elements 53C, 53M, and 53Y are positioned next to each other is represented as the X-direction. The protrusion 821a extends along the direction slanted by θ degrees with respect to the X-direction, and the protrusion 822a extends along the direction slanted by −θ degrees with respect to the X-direction. The protrusions 821a and 822a respectively include ones of different lengths. Likewise, as the protrusion 82b formed in one pixel region, there are two kinds of protrusions 821b and 822b extending along different directions. The protrusion 821b extends along the direction slanted by θ degrees with respect to the X-direction, and the protrusion 822b extends along the direction slanted by −θ degrees with respect to the X-direction. The protrusions 821b and 822b respectively include ones of different lengths. The direction slanted by θ degrees or −θ degrees with respect to the X-direction along which the protrusion 82a or 82b extends is considered as a first or second extending direction.

Regarding each of the pixels including the color elements 53R, 53G, and 53B having almost the same shape and configuring one picture element, the protrusions 821a, 822a, 821b, and 822b are formed in almost the same positions in almost the same shapes. Likewise, regarding each of the pixels including the color elements 53C, 53M, and 53Y having almost the same shape, the protrusions 821a, 822a, 821b, and 822b are formed in almost the same positions in almost the same shapes.

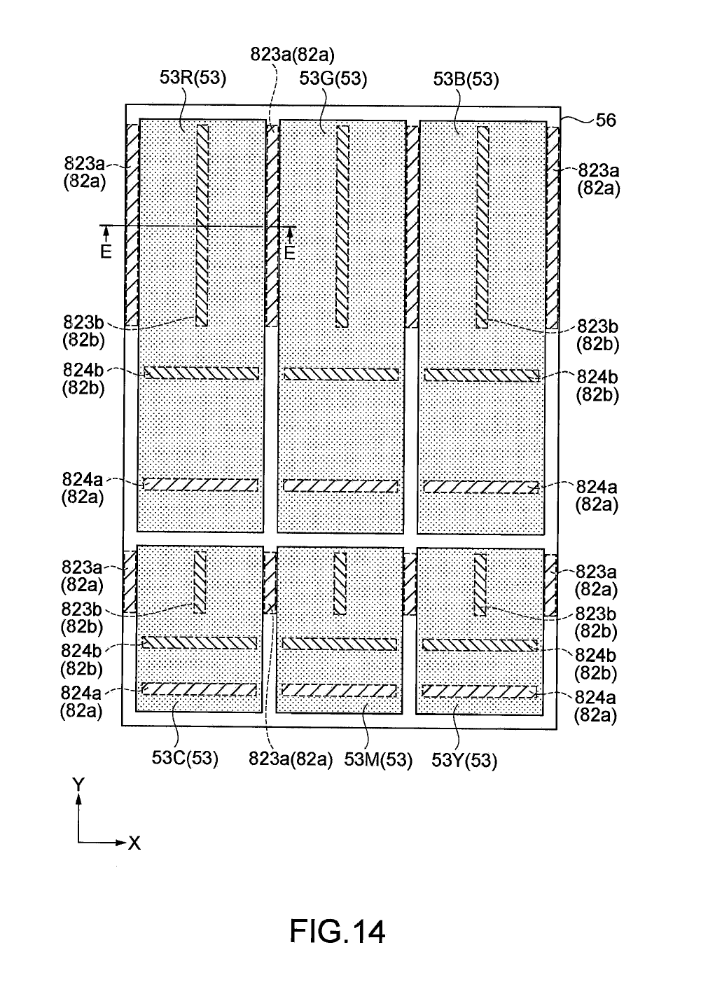

Next, another example of how the protrusions 82a and 82b extend will be described. FIG. 14 is another plan view showing how protrusions extend in one picture element of a six-color filter. The shape of the cross sections taken along the lines E-E in FIG. 14 is substantially equivalent to that of the cross section shown in FIG. 11.

As shown in FIG. 14, one picture element is configured of pixels whose corresponding color elements 53 are the color elements 53R, 53G, and 53B having the three primary colors of light and pixels whose corresponding color elements 53 are the color elements 53C, 53M, and 53Y having the complementary colors of the three primary colors of light. As the protrusion 82a formed in one pixel region, there are two kinds of protrusions 823a and 824a extending along different directions. In this case, as shown in FIG. 14, the direction along which three of the color elements 53 configuring one picture element including the color elements 53R, 53G, and 53B or the other three color elements 53 including the color elements 53C, 53M, and 53Y are positioned next to each other is represented as the X-direction, and the direction parallel to the panel surface and orthogonal to the X-direction is represented as the Y-direction. The protrusion 823a extends along the Y-direction, and the protrusion 824a extends along the X-direction. Likewise, as the protrusion 82b formed in one pixel region, there are two kinds of protrusions 823b and 824b extending along different directions. The protrusion 823b extends along the Y-direction, and the protrusion 824b extends along the X-direction. The protrusions 823b and 824b respectively include ones of different lengths. The X- or Y-direction along which the protrusion 82a or 82b extends is considered as a first or second extending direction.

Regarding each of the pixels including the color elements 53R, 53G, and 53B having almost the same shape and configuring one picture element, the protrusions 823a, 824a, 823b, and 824b are formed in almost the same positions in almost the same shapes, and regarding each of the pixels including the color elements 53C, 53M, and 53Y having almost the same shape, the protrusions 823a, 824a, 823b, and 824b are formed in almost the same positions in almost the same shapes.

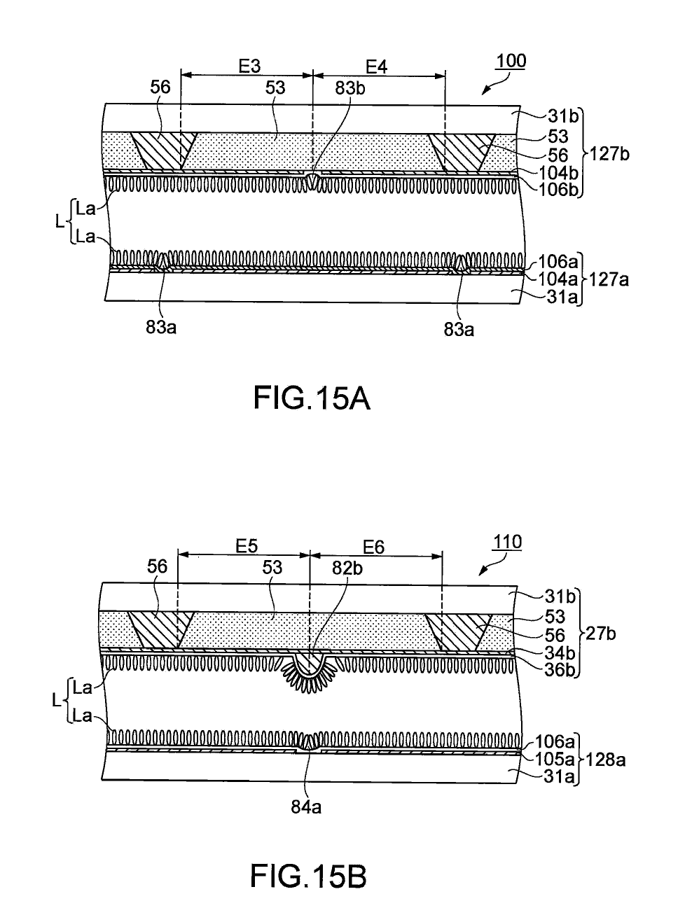

Next, a groove-type alignment-control unit as an example of an alignment-control unit in another shape will be described. FIGS. 15A and 15B are cross-sectional views showing the liquid crystal alignment direction when no drive voltage is applied in a liquid crystal panel including a recess in a surface having contact with a liquid crystal layer. FIG. 15A is a cross-sectional view showing the liquid crystal alignment direction when no drive voltage is applied in a liquid crystal panel including a recess in the first and second substrate surfaces having contact with a liquid crystal layer. FIG. 15B is a cross-sectional view showing the liquid crystal alignment direction when no drive voltage is applied in a liquid crystal panel including a protrusion on the second substrate surface having contact with the liquid crystal layer and a recess in the first substrate surface having contact with the liquid crystal layer.

A first substrate 127a of a liquid crystal panel 100 shown in FIG. 15A includes first electrodes 104a and an alignment layer 106a formed on the base material 31a, as in the case of the earlier-described first substrate 27a. The first electrodes 104a have a slit. The region of the alignment layer 106a formed over the slit sinks into the slit to form a recess 83a. In addition, the reflective layer 32 and the insulating layer 33 are omitted in FIGS. 15A and 15B because they have no influence on liquid crystal alignment direction. A second substrate 127b includes the partitions 56 and the color elements 53 on the base material 31b, and second electrodes 104b and the alignment layer 106b over the partitions 56 and the color elements 53. The second electrodes 104b have a slit. The region of the alignment layer 106b formed over the slit sinks into the slit to form a recess 83b. The first substrate 127a and the second substrate 127b are so bonded together that the alignment layers 106a and 106b face each other with a space in between, with liquid crystal L injected into the space.

In the liquid crystal panel 100 where no drive voltage is applied between the first and second electrodes 104a and 104b, the liquid crystal molecules La of the liquid crystal L are aligned vertically to the alignment layer 106a or 106b, as described above. In the recesses 83a and 83b, the liquid crystal molecules La are aligned almost vertically to the surface of each recess. The liquid crystal molecules L aligned vertically on the sides, etc. of the recesses 83a and 83b are slanted with respect to the vertical-to-panel direction. With the liquid crystal molecules La aligned along the vertical-to-panel direction, the liquid crystal layer prevents the transmission of light.

When a predetermined drive voltage is applied between the first and second electrodes 104a and 104b, the liquid crystal molecules La fall to a direction almost vertical to the electric field direction. With the liquid crystal molecules La aligned almost along the parallel-to-panel direction, the liquid crystal layer allows the transmission of light. When the voltage applied is low and the electric field intensity is weak, the liquid crystal molecules La are aligned at angles corresponding to the electric field intensity between the vertical-to-panel direction and the parallel-to-panel direction. By adjusting this alignment angle, the amount of transmitted light and the pixel brightness are adjusted. By adjusting the brightness of each of the pixels configuring a picture element, the color of the picture element is created.

When a predetermined drive voltage is applied between the first and second electrodes 104a and 104b, the liquid crystal molecules La slanted with respect to the vertical-to-panel direction by being aligned vertically on the sides, etc. of the recesses 83a and 83b fall to the slanted direction. Other liquid crystal molecules La adjacent to the slanted ones fall to the same direction under the influence of the slanted ones. The liquid crystal molecules La in a region E3 in FIG. 15A all fall to one direction, and the liquid crystal molecules La in a region E4 all fall to another direction different from that for the liquid crystal molecules La in the region E3. Therefore, when a drive voltage is applied, regions having different directions for the liquid crystal molecules La to fall are formed with the recess 83a or 83b as dividers. This means that since each color element region 52 which are divided into a plurality of regions by the recess 83a or 83b and whose liquid crystal alignment direction is controlled has different viewing-angle dependencies, the viewing angle of the liquid crystal panel 100 becomes wider. The recess 83a or 83b is equivalent to an alignment-control unit.

The extending directions and positions of the recesses 83a and 83b along the parallel-to-panel direction are the same as those of the protrusions 82a and 82b described with reference to FIGS. 12 to 14.

A first substrate 128a of a liquid crystal panel 110 shown in FIG. 15B includes first electrodes 106a and the alignment layer 106a formed on the base material 31a, as in the case of the earlier-described first substrate 127a. The first electrodes 106a have a slit. The region of the alignment layer 106a formed over the slit sinks into the slit to form a recess 84a. The second substrate of the liquid crystal panel 110, which is the earlier-described second substrate 27b, includes the partitions 56 and the color elements 53 on the base material 31b, and the second electrodes 34b, the protrusion 82b, and the alignment layer 36b over the partitions 56 and the color elements 53. The first and second substrates 128a and 27b are so bonded together that the alignment layers 106a and 36b face each other with a space in between, with liquid crystal L injected into the space. The recess 84a and the protrusion 82b extend along the parallel-to-panel direction and almost parallel to each other. The recess 84a and the protrusion 82b almost overlap with each other in the vertical-to-panel direction.

As described above, in the liquid crystal panel 110 where no drive voltage is applied between the first and second electrodes 105a and 34b, the liquid crystal molecules La of the liquid crystal L are aligned vertically to the alignment layer 106a or 36b. In the recess 84a and on the protrusion 82b, the liquid crystal molecules La are aligned vertically to the surface of the recess or protrusion. The liquid crystal molecules La aligned vertically on the sides, etc. of the recess 84a and the protrusion 82b are slanted with respect to the vertical-to-panel direction. As shown in FIG. 15B, since the recess 84a and the protrusion 82b face and almost overlap with each other in the vertical-to-panel direction, the direction to which the liquid crystal molecules La are slanted under the influence of the recess 84a and the direction to which the liquid crystal molecules La are slanted under the influence of the protrusion 82b are the same.

When a predetermined drive voltage is applied between the first and second electrodes 105a and 34b, the liquid crystal molecules La fall to a direction almost vertical to the electric field direction. With the liquid crystal molecules La aligned almost along the parallel-to-panel direction, the liquid crystal layer allows the transmission of light. When the voltage applied is low and the electric field intensity is weak, the liquid crystal molecules La are aligned at angles corresponding to the electric field intensity between the vertical-to-panel direction and the parallel-to-panel direction. By adjusting this alignment angle, the amount of transmitted light and the pixel brightness are adjusted. By adjusting the brightness of each of the pixels configuring a picture element, the color of the picture element is created.

When a predetermined drive voltage is applied between the first and second electrodes 105a and 34b, the liquid crystal molecules La slanted with respect to the vertical-to-panel direction by being aligned vertically on the sides, etc. of the recess 84a and the protrusion 82b fall to the slanted direction. Other liquid crystal molecules La adjacent to the slanted ones fall to the same direction under the influence of the slanted ones. The liquid crystal molecules La in a region E5 in FIG. 15B all fall to one direction, and the liquid crystal molecules La in a region E6 all fall to another direction different from that for the liquid crystal molecules La in the region E5. Therefore, when a drive voltage is applied, regions having different directions for the liquid crystal molecules La to fall are formed with the recess 84a and the protrusion 82b as dividers. This means that since each color element region 52 which are divided into a plurality of regions by the recess 84a and the protrusion 82b and whose liquid crystal alignment direction is controlled has different viewing-angle dependencies, the viewing angle of the liquid crystal panel 110 becomes wider. In addition, since the liquid crystal molecules La fall to two opposing directions with the recess 84a and the protrusion 82b as dividers when a drive voltage is applied, a dividing point where the direction for the liquid crystal molecules La to fall is reversed appears in the midpoint between the adjacent recesses 84a and the protrusions 82b. In FIG. 15B, the dividing point appears near the center of each partition 56. The recess 84a or the protrusion 82b is equivalent to an alignment-control unit.

The extending direction and position of the protrusion 82b along the parallel-to-panel direction in the liquid crystal panel 110 are the same as those of the protrusion 82b described with reference to FIGS. 12 to 14. The extending direction and position of the recess 84a along the parallel-to-panel direction also roughly overlap with those of the protrusion 82b described with reference to FIGS. 12 to 14.

Next, an advantageous effect of the first embodiment will be described.

(1) The protrusions 82a, 82b, the recesses 83a, 83b, or the protrusion 84a as alignment-control units extend along the same direction in each position corresponding to the color elements 53 for the respective colors configuring a picture element. Hence, the alignment direction of liquid crystal is the same at each of the pixels for the respective colors configuring a picture element. Therefore, the alignment direction of liquid crystal is the same at each of the pixels, i.e., color elements 53, configuring a picture element. Consequently, the viewing angle can be widened while the color balance of the picture element is maintained.

### Second Embodiment

Next, an electronic device according to a second embodiment of the invention will be described. The electronic device of the second embodiment is an electronic device having the liquid crystal display described in the first embodiment. A specific example of the electronic device of the second embodiment will be described.

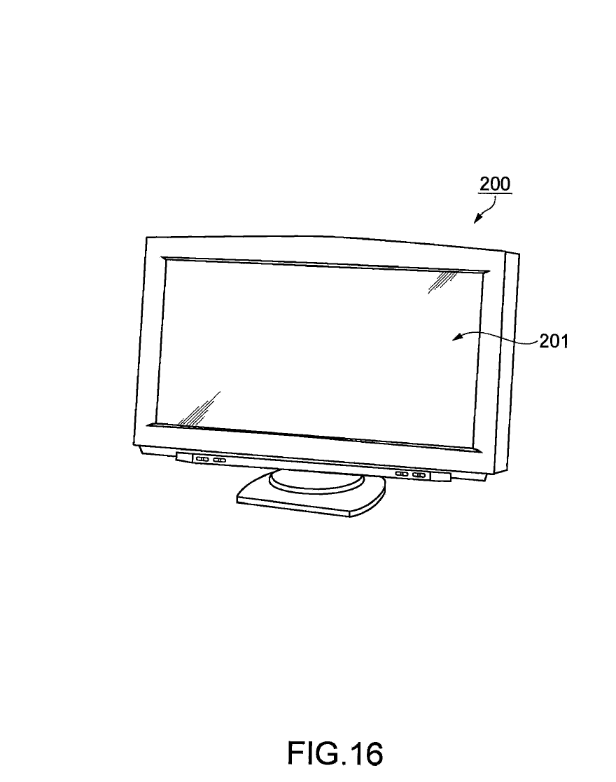

FIG. 16 is an external perspective view showing a large liquid crystal television as an example of the electronic device. As shown in FIG. 16, a large liquid crystal television 200 as an example of the electronic device has a display 201. The display 201 includes the liquid crystal display 21 described in the first embodiment as a displaying element.

Next, an advantageous effect of the second embodiment will be described.

(1) Since the large liquid crystal television 200 includes the liquid crystal display 21 in which the alignment direction of liquid crystal is the same at each of the color elements and the viewing angle can be widened while the color balance of the picture element is maintained, the large liquid crystal television 200 having a preferable color balance and a wide viewing angle can be achieved.

While the preferred embodiments according to the invention have been described with reference to the accompanying drawings, the embodiments of the invention are not limited thereto. The invention is not limited to the above embodiments and, of course, various modifications may be made thereunto without departing from the scope of the invention, including the following.

Modification 1

Although liquid crystal panels having electrodes in a stripe pattern on the upper and lower substrates have been described in the embodiments, the display may not necessarily be a liquid crystal panel having electrodes in a stripe pattern. The display may also be a thin-film-transistor (TFT) panel in which pixels are controlled with TFTs, or a thin-film-diode (TFD) panel in which pixels are controlled with TFDs. In a TFT or TFD panel, an element substrate on which TFTs or TFDs are formed is equivalent to an electrode substrate, and a substrate facing the element substrate is equivalent to an opposing substrate.

Modification 2

Although the embodiments have been described taking a liquid crystal display based on a multi-domain vertical alignment (MVA) method as an example, the liquid crystal display may also be based on an in-plane switching (IPS) method. In that case, the space between adjacent electrodes is equivalent to an alignment-control unit.

Modification 3

Although the recesses 83a, 83b, and 84a are formed by configuring a slit in pixel electrodes such as the first electrodes 104a, the second electrodes 104b, and the first electrodes 106a in the embodiments, the recess may not necessarily be formed by configuring a slit in pixel electrodes. The recess may also be formed by forming the same material as that used in forming the protrusion on the entire surface excluding one region, which is to be the recess.

Modification 4

Although the case of a four-color filter where the alignment-control unit extends along the same direction at each of the pixels for the color elements 53 of all colors has been described in the embodiments, the alignment-control unit may not necessarily extend along the same direction at each of the pixels for the color elements 53 of all colors. A configuration where the alignment-control unit extends along the same direction at each of the pixels for the color elements 53 of at least three colors may also be employed.

Modification 5

Although the case of a six-color filter where the alignment-control unit extends along the same direction at each of the pixels for the color elements 53 of all colors has been described in the embodiments, the alignment-control unit may not necessarily extend along the same direction at each of the pixels for the color elements 53 of all the six colors. A configuration where the alignment-control units extend along the same direction at each of the pixels for the color elements 53 of at least the three primary colors of light may also be employed. Alternatively, a configuration where the alignment-control unit extends along the same direction between the color elements 53 of at least the three primary colors of light and between the color elements 53 of the colors complementary to the three primary colors may also be employed.

Modification 6

Although the case of a six-color filter where the alignment-control unit extends along the same direction at each of the pixels for the color elements 53 of all colors has been described in the embodiments, the alignment-control unit may not necessarily extend along the same direction at each of the pixels for the color elements 53 of all the six colors. A configuration where the alignment-control unit extends along the same direction at each of the pixels for the color elements 53 having at least any of the three primary colors of light and the pixels for the color elements 53 having the color complementary to the former one may also be employed.

Modification 7

Although the protrusion 82a, 82b, the recess 83a, 83b, or 84a is provided as an alignment-control unit to both of the first and second substrates 27a and 27b or 127a and 127b in the embodiments, the alignment-control unit may not necessarily be provided to both of the first and second substrates. A configuration where the alignment-control unit is provided to either the first or second substrate may also be employed.

Modification 8

Although the cases of four-color and six-color filters have been described in the embodiments, the multi-color filter may not necessarily be a four-color or six-color filter. The number of colors for the color elements may be any number if four or more.

Modification 9

Although a color filter having four kinds of color elements 53 including red (R), green (G), blue (B), and water-clear (W) has been described as a four-color filter in the embodiments, the colors of a four-color filter may not necessarily be the four colors of red (R), green (G), blue (B), and water-clear (W). For example, a four-complementary-color filter having not only the three colors of cyan, magenta, and yellow but also green, or a four-color filter including the color elements of other four colors may also be employed.

Modification 10

Although a color filter having six kinds of color elements 53 including red (R), green (G), blue (B), cyan (blue-green), magenta (purple-red), and yellow has been described as a six-color filter in the embodiments, the colors of a six-color filter may not necessarily be the six colors of red (R), green (G), blue (B), cyan (blue-green), magenta (purple-red), and yellow. A six-color filter including the color elements of other six colors may also be employed.

Modification 11

Although the case where the protrusion 82, recess 83, or recess 84 having two extending directions is formed in one color element 53 has been described in the embodiments, the alignment-controlling member included in one color element 53 may not necessarily extend along two different directions. The alignment-controlling member included in one color element 53 may extend along one direction or three or more directions.

Modification 12

Although the color filter is formed on the second substrate in the embodiments, the color filter may not necessarily be formed on the second substrate. A configuration having a color filter on the first substrate may also be employed. In a TFT panel for example, a color filter may be formed on an element substrate having TFTs, or on an opposing substrate facing the element substrate through a liquid crystal layer.

Modification 13

Although the color element regions 52 are formed by providing the partitions 56 and the color elements 53 are formed by feeding the color element regions 52 with coloring materials in the embodiments, the partitions 56 may not necessarily be provided. A configuration where the color elements 53 are in direct contact with each other may also be employed.

Modification 14

Although a droplet ejection method is used for forming the partitions 56 and the color elements 53 in the embodiments, the partitions 56 and the color elements 53 may not necessarily be formed by a droplet ejection method. The partitions 56 and the color elements 53 may be formed by other methods such as photolithography, printing, etc.

Modification 15

Although a liquid crystal display which displays an image on its display surface have been described as the liquid crystal device in the embodiments, the invention can also be applied to other devices using liquid crystal such as a liquid crystal projector, etc. than the liquid crystal display which displays an image on its display surface.

Modification 16

Although the areas of the color elements 53C, 53M, and 53Y for cyan (C), magenta (M), and yellow (Y), the complementary colors of the three primary colors of light including red (R), green (G), and blue (B), are smaller than those of the color elements 53R, 53G, and 53B for red (R), green (G), and blue (B) in the six-color filter of the embodiments, the areas of the color elements 53C, 53M, and 53Y may not necessarily be smaller than those of the color elements 53R, 53G, and 53B. The areas of the color elements 53C, 53M, and 53Y may be larger than those of the color elements 53R, 53G, and 53B, or the areas of the color elements 53C, 53M, and 53Y may be the same as those of the color elements 53R, 53G, and 53B.

Modification 17

Although the shape of the color element 53, i.e., the shape of a pixel, is a rectangle and the shape of a picture element configured of a combination of the pixels is also a rectangle in the embodiments, the shapes of a pixel and a picture element may not necessarily be rectangles. A configuration where triangular pixels are combined to form a triangular, trapezoidal, or hexagonal picture element or a configuration where hexagonal pixels are combined to form a picture element may also be employed. Further, a configuration where pixels of different shapes are combined to form a picture element may also be employed.

Modification 18

Although the picture element filters 54 and 57 of the embodiments include the color elements 53 one each for the respective colors included in the picture element, the number of the color elements configuring one picture element may not necessarily be one for each color. A picture element filter where a plurality of color elements having the same color are scatteringly arranged in one picture element filter may also be employed.

The entire disclosure of Japanese Patent Application No. 2006-42008, filed Feb. 20, 2006 is expressly incorporated by reference herein.

What is claimed is:

1. A liquid crystal device comprising:
an electrode substrate having a plurality of pixel electrodes;
an opposing substrate facing the electrode substrate;
a color filter having a color element each facing each of the plurality of pixel electrodes;
a liquid crystal sandwiched between the electrode substrate and the opposing substrate; and
an alignment-control unit extending on a surface having contact with the liquid crystal in at least one of the electrode substrate and the opposing substrate,
wherein colors for the color element include four or more colors and the alignment-control unit extends along a same direction in each position corresponding to the color element for at least any of predetermined three of the four or more colors.

2. The liquid crystal device according to claim 1, wherein the alignment-control unit formed in each position corresponding to the color element for a color other than the predetermined colors extends along a same direction as that for the alignment-control unit formed in each position corresponding to the color element for any of the predetermined colors.

3. The liquid crystal device according to claim 1, wherein the predetermined colors are three primary colors including red, green, and blue.

4. The liquid crystal device according to claim 3, wherein the alignment-control unit extends along a same direction in each position corresponding to the color element for a color other than the three primary colors.

5. The liquid crystal device according to claim 1, wherein the predetermined colors are any of cyan, magenta, and yellow, which are complementary colors of the three respective primary colors including red, green, and blue.

6. The liquid crystal device according to claim 5, wherein the alignment-control unit extends along a same direction in each position corresponding to the color element for a color other than the complementary colors of the three primary colors.

7. A liquid crystal device comprising:
an electrode substrate having a plurality of pixel electrodes;
an opposing substrate facing the electrode substrate;
a color filter having a color element each facing each of the plurality of pixel electrodes;
a liquid crystal sandwiched between the electrode substrate and the opposing substrate; and
an alignment-control unit extending on a surface having contact with the liquid crystal in at least one of the electrode substrate and the opposing substrate,
wherein colors for the color element include three primary colors such as red, green, and blue and complementary colors regarding the three primary colors such as cyan, magenta, and yellow for color elements, and the alignment-control unit extends along a same direction in each position corresponding to the color element for any of the three primary colors, and
the alignment-control unit extends along a same direction in each position corresponding to the color element for any of the complementary colors regarding the three primary colors.

8. A liquid crystal device comprising:
an electrode substrate having a plurality of pixel electrodes;
an opposing substrate facing the electrode substrate;
a color filter having a color element each facing each of the plurality of pixel electrodes;
a liquid crystal sandwiched between the electrode substrate and the opposing substrate; and
an alignment-control unit extending on a surface having contact with the liquid crystal in at least one of the electrode substrate and the opposing substrate,
wherein colors for the color element include three primary colors such as red, green, and blue and complementary colors regarding the three primary colors such as cyan, magenta, and yellow and the alignment-control unit extends along a same direction in each position corresponding to the color element for any of the complementary colors regarding the three primary colors.

9. A liquid crystal device comprising:
an electrode substrate having a plurality of pixel electrodes;
an opposing substrate facing the electrode substrate;
a color filter having a color element each facing each of the plurality of pixel electrodes;
a liquid crystal sandwiched between the electrode substrate and the opposing substrate; and
an alignment-control unit extending on a surface having contact with the liquid crystal in at least one of the electrode substrate and the opposing substrate,
wherein the color element includes a first color element having a first area as an effective area for light transmission; and a second color element having a second area as the effective area,
wherein the alignment-control unit extends along a same direction in each position corresponding to at least one of the first color element and the second color element between colors of the first color element or between colors of the second color element.

10. A liquid crystal device comprising:
an electrode substrate having a plurality of pixel electrodes;
an opposing substrate facing the electrode substrate;
a color filter having a color element each facing each of the plurality of pixel electrodes;
a liquid crystal sandwiched between the electrode substrate and the opposing substrate; and
an alignment-control unit extending on a surface having contact with the liquid crystal in at least one of the electrode substrate and the opposing substrate,
wherein the color element includes a first color element having a first area as an effective area for light transmission; and a second color element having a second area as the effective area,
wherein the direction along which the alignment-control unit extend is determined for each color and
the alignment-control unit formed in each position corresponding to the first color element having a first color extends along a same direction as that for the alignment-control unit formed in each position corresponding to the second color element having a second color complementary to the first color.

11. The liquid crystal device according to claim 7, wherein the alignment-control unit extends along a same direction in each position corresponding to each of the color elements.

12. The liquid crystal device according to claim 1, wherein the direction along which the alignment-control unit extend includes a first extending direction and a second extending direction; and the alignment-control unit corresponding to one color element includes both the alignment-control unit provided along the first extending direction and the alignment-control unit provided along the second extending direction.

13. The liquid crystal device according to claim 1, wherein the alignment-control unit is a protrusion formed on the surface having contact with the liquid crystal or a recess formed in the surface having contact with the liquid crystal.

14. The liquid crystal device according to claim 13, wherein either or both of the protrusion and the recess are formed for each of the color elements.

15. The liquid crystal device according to claim 13, wherein the recess is formed by providing a slit in the pixel electrode.

16. The liquid crystal device according to claim 1, wherein the alignment-control unit is a space between adjacent pixel electrodes.

17. An electronic device comprising:
the liquid crystal device according to claim 1.
